(19) United States
(12) Patent Application Publication
(10) Pub. No.: US 2019/0391796 A1
(43) Pub. Date: Dec. 26, 2019

(54) CONTROL OF SCHEDULING DEPENDENCIES BY A NEURAL NETWORK COMPILER

(71) Applicant: Intel Corporation, Santa Clara, CA (US)

(72) Inventors: John Brady, Celbridge (IE); Marco Mecchia, Maynooth (IE); Patrick F. Doyle, Hillsboro, OR (US); Meenakshi Venkataraman, San Jose, CA (US); Stanislaw Jan Maciag, Dublin (IE)

(73) Assignee: Intel Corporation, Santa Clara, CA (US)

(21) Appl. No.: 16/457,772

(22) Filed: Jun. 28, 2019

(51) Int. Cl. G06F 8/41; G06N 3/04; G06F 16/901

(52) U.S. Cl. CPC G06F 8/458; G06F 16/9024; G06N 3/04

(57) ABSTRACT

A compiler receives a graph describing a neural network and accesses data to describe a target computing device to implement the neural network. The compiler generates an intermediate representation from the graph and the data, and determines dependencies between operations identified in the intermediate representation. A set of barrier tasks are determined to be performed to control flow of the set of operations based on the dependencies, where the set of barrier tasks are to be performed using hardware barrier components on the target computing device. Indications of the barrier tasks are inserted into the intermediate representation. The compiler generates a binary executable from the intermediate representation to enable performance of the barrier tasks to control performance of the set of operations at the target computing device.

### TECHNICAL FIELD

This disclosure relates in general to the field of computer systems and, more particularly, to compilers for machine learning computing systems.

### BACKGROUND

Machine learning models are models, which may be implemented by computing systems to receive an input and generate an output (e.g., a predicted output) based on the received input. Some machine learning models are parametric models and generate the output based on the received input and on values of the parameters of the model. Machine learning models may also include deep learning models that employ multiple layers of models to generate an output for a received input. For example, a deep neural network is a deep machine learning model that includes an output layer and one or more hidden layers that each apply a non-linear transformation to a received input to generate an output. Some neural networks are recurrent neural networks. A recurrent neural network is a neural network that receives an input sequence and generates an output sequence from the input sequence. In particular, a recurrent neural network uses some or all of the internal state of the network after processing a previous input in the input sequence in generating an output from the current input in the input sequence. Specialized computing systems have been developed to more efficiently and effectively implement and use such machine learning models.

### BRIEF DESCRIPTION OF THE DRAWINGS

FIG. 1 is a simplified block diagram of an example compiler configured for use with deep learning computing systems.

FIG. 2 is a simplified block diagram of an example electronic device that includes a machine learning device in accordance with some embodiments.

FIG. 3 is a simplified block diagram of an example machine learning device in accordance with some embodiments.

FIG. 4 is a block diagram illustrating an example an improved memory subsystem in accordance with some embodiments.

FIG. 5 is a block diagram of an example hardware accelerator device in accordance with some embodiments.

FIG. 6 is a block diagram illustrating use of memory resources by example processor elements in an example hardware accelerator device in accordance with some embodiments.

FIG. 7 is a simplified block diagram of a subsystem of an example machine learning device in accordance with some embodiments.

FIG. 8 is a simplified block diagram illustrating an example processor a machine learning system.

FIG. 9 is a simplified flow diagram illustrating an example volumetric acceleration unit of an example processor device.

FIG. 10 is a simplified block diagram illustrating an example compiler and an example intermediate representation generated by the compiler.

FIG. 11A is a simplified block diagram of an example operation model of an example intermediate representation of a neural network graph.

FIG. 11B is a simplified block diagram of an example data model of an example intermediate representation of a neural network graph.

FIG. 11C is a simplified block diagram of an example control model of an example intermediate representation of a neural network graph.

FIG. 12 is a simplified block diagram of an example compiler.

FIG. 13 is a simplified block diagram of an example control model of an example intermediate representation.

FIG. 14 is a simplified block diagram illustrating memory allocation in an example compilation process.

FIGS. 15A-15B illustrate a flowchart showing an example compilation process performed by a compiler.

FIGS. 16A-16C illustrate a first example of a graph model with inserted barrier task objects.

FIGS. 17A-17E illustrate a second example of a graph model with inserted barrier task objects.

FIG. 18 is a flowchart illustrating an example technique for generating a binary executable using an example compiler.

FIG. 19 is a block diagram of an exemplary processor in accordance with one embodiment.

FIG. 20 is a block diagram of an exemplary computing system in accordance with one embodiment.

Like reference numbers and designations in the various drawings indicate like elements.

### DETAILED DESCRIPTION OF EXAMPLE EMBODIMENTS

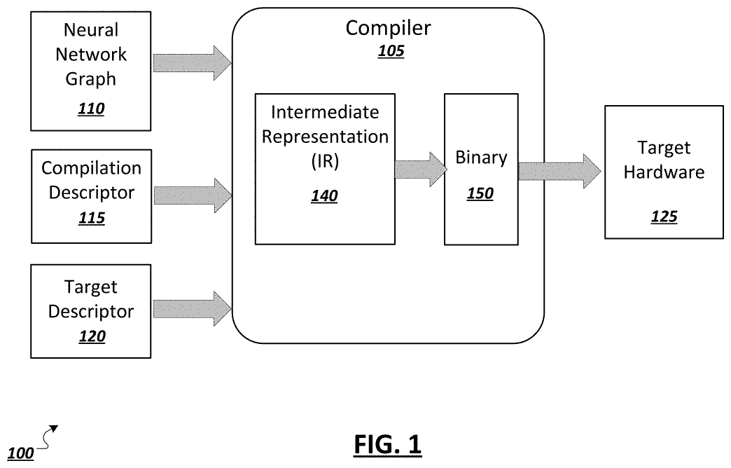

FIG. 1 is a simplified block diagram 100 showing an example compiler adapted to generate executable code from machine learning models in a manner adapted to optimize, or efficiently and intelligently utilize, the processing, memory, and interconnect resources of particular target machine learning hardware to be utilized in consuming and executing the machine learning model. For instance, a machine learning model, such as a graph definition 110 of an example neural network model (or other deep learning model) may be provided as an input for consumption by an example neural network compiler 105. Compilation descriptor data 115 may be provided to indicate one or more compilation sweeps to be performed based on attributes of one or both of the neural network model and/or the underlying hardware, as well as target descriptor data 120 to describe attributes of a target hardware processing device 125, which is targeted for executing the code to be generated by the compiler 105 from the graph definition 110. In some implementations, the hardware processing device 125 may be a parallel processing device, with multiple processing elements utilizing shared memory, where heterogenous technologies may be employed between the processing elements and/or shared memory elements utilized within the device 125. The compiler 125 may utilize these inputs to generate an intermediate representation (IR) 140, which includes multiple models 145 to represent the manageable resources provided by processing device 125. Such resources may include memory resources 130 and computation resources 135 (among other resources, such as communication or interconnect resources). Specific models 145 within the IR 140 may provide views of the memory resources 130 (e.g., through a data model) and computation resources 135 (e.g., a control model), among other example models provided within the generated IR to provide views for use in generating, through a set of compilation passes, code 150 (e.g., a binary), which is generated automatically by the compiler 105 as code optimized to the architecture and resources of the processing device 125.

Traditionally, general purpose compilers, such as GCC and LVMM compliers, have proved ill-suited to generating code for deep-learning applications involving dense and sparse linear algebraic operations. Further, as specialized hardware is increasingly developed and utilized to handle machine learning applications, the assumptions underlying traditional compilers may no longer be valid, further making such compilers poor candidates for use in machine learning applications. As a result, manual coding and optimization (as performed and implemented manually by human engineers) is often relied upon to implement machine learning systems, as such “handwritten” assembly code is generally regarded as surpassing the performance of code that is output by general-purpose compilers. For instance, some of the example issues and limitations of example general purpose compilers may include designs assuming that the code is being compiled for a single, synchronous compute unit or multiple devices with particular forms of parallelism and shared memory capabilities. As another example, general-purpose compilers may be configured for scale or vector instructions sets, and may be unable to map computations programs onto broader types of instructions like matrix multiplication. Additionally, general-purpose compilers may be built to assume a particular form of memory hierarchy, with a large main memory accessible by the CPU and a cache hierarchy on the chip that is managed completely by hardware, among other features, which limit the ability of such traditional compilers to handle and optimize workloads involved in modern (and evolving) machine learning applications.

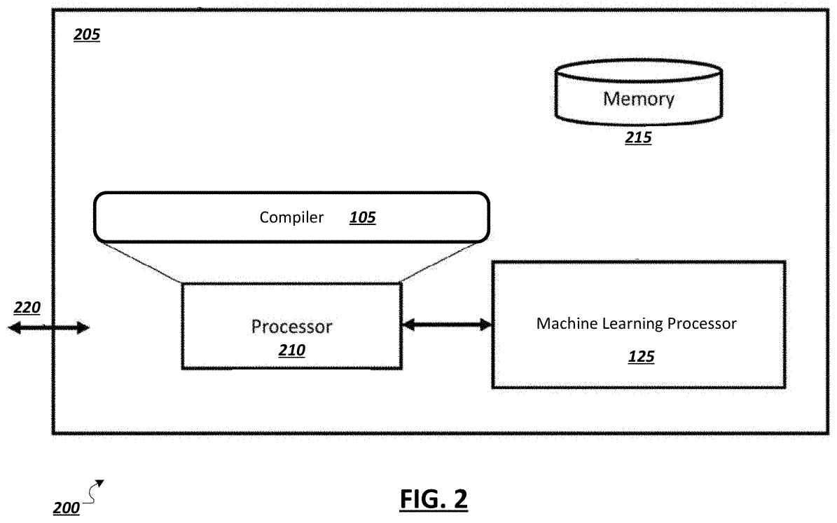

Turning to FIG. 2, a simplified block diagram 200 is shown of an example computing system 205 configured for handling machine learning applications. For instance, the computing system may be embodied as one or more devices (e.g., on one or more packages or dies) utilize a machine learning processing device 125, such as vision processing unit (VPU) or other parallel processing device, configured to effectively execute operations associated with deep learning applications. The computing system 205, in this example, may include a general-purpose processing device 210 (e.g., a CPU) with one or more cores, one or more memory elements 215, and one or more one or more interfaces 220 together with one or more machine learning processor devices (e.g., 125).

In some implementations, an example system 205 may have memory 215 such as a computer readable medium, flash memory, a magnetic disk drive, an optical drive, a programmable read-only memory (PROM), and/or a read-only memory (ROM). The system 205 may be configured with one or more processors 210 that process instructions and run software that may be stored in memory 215. The processor 205 can also communicate with the memory 215 and interfaces 220 to communicate with other devices. The processor 210 can be any applicable processor such as a system-on-a-chip that combines a CPU, an application processor, and flash memory, or a reduced instruction set computing (RISC) processor.

In some embodiments, an example compiler (e.g., 105), such as an example neural network compiler such as discussed herein, as well as other components, may be implemented in software stored in memory 215, and operate on the processor 210. The memory 215 can be a non-transitory computer readable medium, flash memory, a magnetic disk drive, an optical drive, a programmable read-only memory (PROM), a read-only memory (ROM), or any other memory or combination of memories. The software can run on a processor capable of executing computer instructions or computer code. The processor might also be implemented in hardware using an application specific integrated circuit (ASIC), programmable logic array (PLA), field programmable gate array (FPGA), or any other integrated circuit. In some embodiments, the compiler 105 can be implemented in a separate computing device in communication with the system 205 over an interface (e.g., 220). For example, the compiler 105 can operate in a server in communication with the system 205, among other example implementations.

Interfaces (e.g., 220) of an example system may be implemented in hardware or software. The interfaces 220 can be used to receive both data and control information from the network as well as local sources, such as a remote control to a television. The electronic device can also provide a variety of user interfaces such as a keyboard, a touch screen, a trackball, a touch pad, and/or a mouse. The electronic device may also include speakers and a display device in some embodiments.

In some embodiments, a processing element in the machine learning processing device 125 can include an integrated chip capable of executing computer instructions or computer code. The processor might also be implemented in hardware using an application specific integrated circuit (ASIC), programmable logic array (PLA), field programmable gate array (FPGA), or any other integrated circuit. In some embodiments, the machine learning device 125 can be implemented as a system on chip (SOC). In other embodiments, one or more blocks in the parallel processing device can be implemented as a separate chip, and the parallel processing device can be packaged in a system in package (SIP). In some embodiments, the machine learning device 125 can be used in machine learning applications. In some cases, the features of an example machine learning device enabling the device's effectiveness in machine learning applications may also be used in other data processing applications. Indeed, an example machine learning device 125 may not be purpose-built exclusively or specifically for machine learning, but may instead be equipped with hardware to make the composite operations relating to machine learning (and potentially other, non-machine-learning applications) more efficient. For instance, an example machine learning device 125 may be implemented as a parallel processing device well-configured to also handle image processing applications, video processing applications, and other example applications. Example machine learning application may include applications such machine learning and classification based on sequence of images, objects or video and augmented reality applications, computer vision, autonomous navigation, and other applications.

In some implementations, an example system 205 may be implemented as a computer device, such as a personal computing device, mobile computing device, server computing system (e.g., a rack scale, blade server, or other server computer), among other examples. The system 205 may run an operating system such as Windows, Linux, iOS, Symbian OS, iPhone OS, Windows Mobile, Android, among other examples. Through such an operating system (or virtual machines or software containers implemented on the system), the system 205 may have the capability to run applications locally and/or communicate with applications that are provided by remote servers in the communications network. Such systems may be implemented in a variety of form factors and embodiments, such as smart televisions (TVs), video projectors, set-top boxes or set-top units, digital video recorders (DVR), computers, netbooks, laptops, tablet computers, wearable devices, Internet of Things (IoT) devices, and among other example implementations.

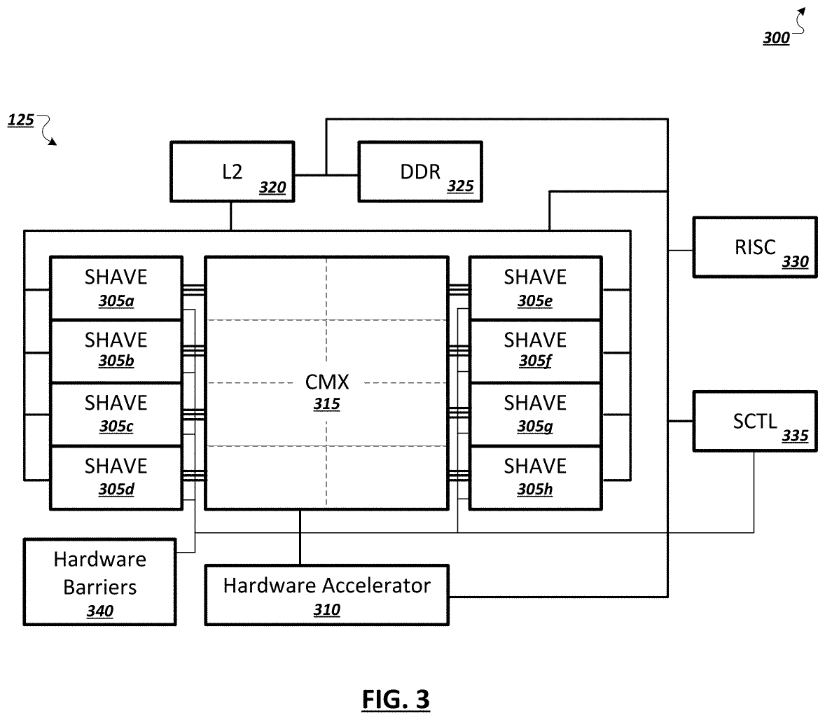

FIG. 3 is a simplified block diagram 300 of an example machine learning processing device 125, in accordance with some example implementations. In this particular example, a machine learning device 125 may implement a VPU that includes a set of special-purpose processors 305a-h, a machine learning accelerator 310, and non-standard memory hierarchy 315, and multiple types of memory (e.g., 320, 325). For instance, multiple processors 305a-h (e.g., Streaming Hybrid Architecture Vector Engine (SHAVE) processors) may share a multiport memory subsystem 315 in accordance with some embodiments. Such processors 305a-h may be implemented as proprietary or special-purpose processors with very long instruction word (VLIW) instruction sets, among other examples. The memory subsystem 315 may be implemented as a collection of memory slices, referred to herein as “connection matrix” (CMX) slices. CMX memory 315 may be implemented as fast, local memory (e.g., SDRAM) and can embody scratchpad memory usable by individual processors (e.g., 305a-h). Layer 2 (L2) cache 320 and DDR memory 325 may be further provided as more general-purpose, or system, memory, in this example. Further an example machine learning processing device may further include a reduced instruction set computer (RISC) element 330, as well as other processor devices (e.g., 335).

One or more hardware accelerator devices (e.g., 310) may be included in or coupled to the machine learning processing device. Such accelerator devices may be fixed-function hardware accelerators configured particularly to support matrix arithmetic, particular machine learning operations, or other specialized functions to enhance the overall capabilities of the machine learning processing device 125. In one example, the accelerator device may itself include a number of data processing units (DPUs), which may connect to and also make use of the memory subsystem 315, among other example features and components. In the example of FIG. 3, example memory subsystem 315 may include or define specific memory regions where specific tensor types are required to reside (e.g., populated, unpopulated, network input and output tensors). These and other examples features of an example machine learning processing device 125 may complicate the application of traditional compilers to such architectures.

In some implementations, such as illustrated in the example of FIG. 3, an example machine learning device (e.g., 125) may include a set of hardware barrier resources 340, which may be utilized to enhance synchronization of tasks performed using the machine learning device 125. Hardware barrier devices may be a physical implementation of counting semaphores for use in real-time task synchronization. In some implementations, hardware barrier devices may be implemented as a collection of counter devices. Hardware barrier devices act as semaphores to pause the start of “consumer” tasks dependent upon completion of preceding “producer” dependencies. In some implementation, counter circuitry of each hardware barrier device 340 may allow aggregation of multiple dependencies in a compact and fast implementation. In some implementations, utilizing hardware barriers for task synchronization may greatly improve runtime performance versus a software-based semaphore or time-slot task synchronization approach.

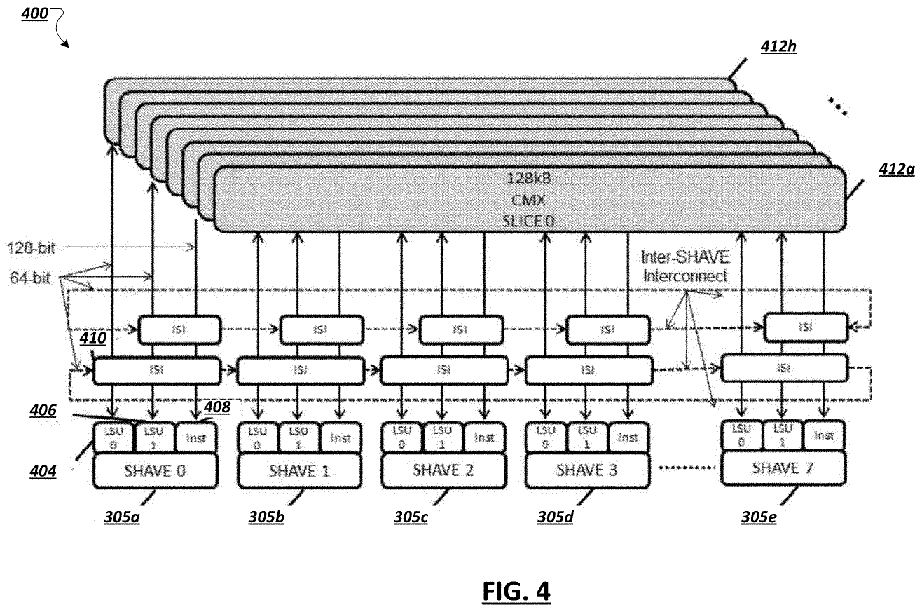

Turning to FIG. 4, a simplified block diagram 400 is shown illustrating a view of the memory interactions within an example machine learning processing device, such as discussed in the example of FIG. 3. Specifically, FIG. 4 shows a set of eight SHAVE processors (305a-h). In this example, each SHAVE processor can include two load store units (e.g., 404, 406 (LSU0, LSU1)) by which data may be loaded from and stored to CMX slices (e.g., 412a-h) of the memory subsystem memory 315. Each memory slice 412a-h may be associated with a corresponding one of SHAVE processors (305a-h). Further, each SHAVE processors (305a-h) can also include an instruction unit (e.g., 408) into which instructions may be loaded. A particular embodiment in which the processor includes a SHAVE, the SHAVE can include one or more of a reduced instruction set computer (RISC), a digital signal processor (DSP), a very long instruction word (VLIW), and/or a graphics processing unit (GPU). An example machine learning processing device may additional include an interconnection system 410 that couples the processors 305a-h and the memory slices 412a-h. The interconnection system 410 may be referred to as an inter-shave interconnect (ISI). The ISI can include a bus through which processors (e.g., 305a-h) can read or write data to any part of any one of the memory slices (e.g., 412a-h), among other example communications and transactions.

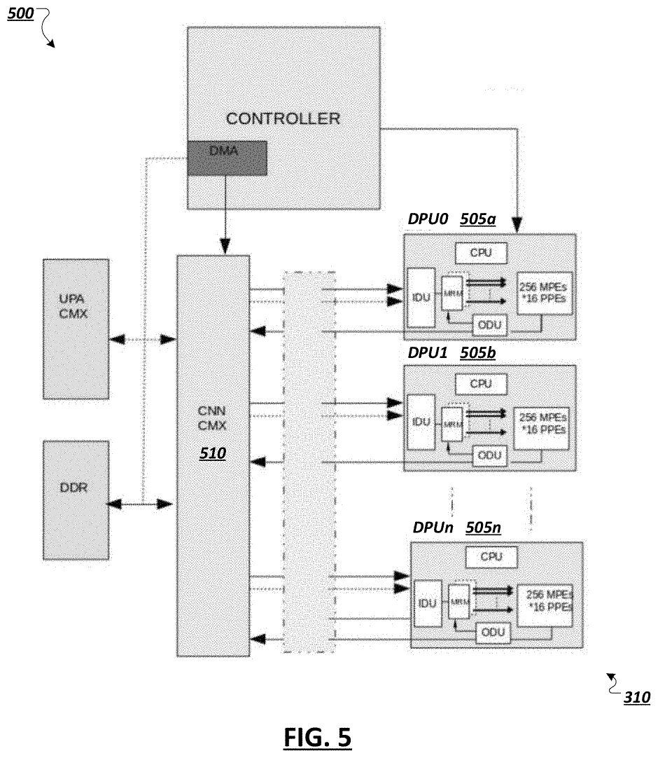

A variety of different hardware accelerator devices may be connected to and/or included within an example machine learning device. For instance, turning to FIG. 5, a simplified block diagram 500 is shown of an example implementation of a hardware accelerator 310. A hardware accelerator may be provided, such as circuitry of an example neural compute engine, which may be leveraged by the machine learning device to offload performance of one or more deep neural operations. A hardware accelerator may include a collection of data processing units (e.g., 505a-n), which may be connected to (and even include) a portion of memory 510 (e.g., CMX memory) of the memory hierarchy of the machine learning device (e.g., by one or more interconnects 515 coupling the hardware accelerator to the memory subsystem). For instance, in one example, an accelerator 310 may include 20 (or more) data processing units (DPUs) 505a-n connected to 4 MB of dedicated (e.g., internal) CMX memory for input activation and weight storage. Additional CMX memory (e.g., 515) may be provided off-chip (e.g., outside the accelerator device) as well as other off-chip memory 520 (e.g., implemented as DDR memory), among other examples. A memory controller (e.g., 525) may also be provided to govern how various components access elements of the memory subsystem. In some implementations, the memory controller 525 may include a direct memory access (DMA) engine (e.g., 530), among other example components.

In one example, a data processing unit (e.g., 505a-n) of an accelerator device may include a central processing unit (CPU). An input delivery unit (IDU) may access neural network data and provide the data to multi-read memory (MRM) of the DPU. A variety of processing elements may be provided to operate on the data. For instance, the processing elements may include a set of multiply accumulate (MAC) processing elements (e.g., MAC+pool) may be implemented through MAC processing elements (MPEs). Processing elements may additionally include a number of post processing elements (PPEs) (e.g., to provide flex compute). In the example of FIG. 5, a PPE may be provided for every 16 MPEs, although other rations and implementations may be provided in other examples. An example DPU may additionally include output delivery units (ODUs), for instance, to return results of the processing elements and perform various post-processing tasks on the results (e.g., data/tensor remapping, compression, etc.). Other (or additional) accelerator devices may be coupled and included in an example machine learning device, in other implementations.

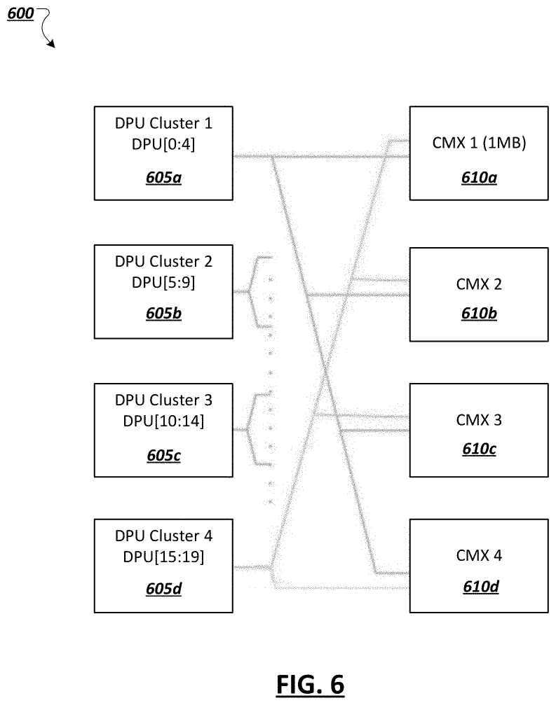

In some implementations, random access to CMX memory may not be possible due to a relatively high number of data processing units included in an example accelerator device. In one example, DPUs 505a-n may be organized into clusters (e.g., 4 clusters of 5 DPUs). Each cluster may be assigned preferred access (e.g., higher bandwidth, priority access, etc.) to a particular section of the CMX memory (e.g., 1 MB slice). In some implementations, a given cluster may additionally read/write to other CMX slices not assigned to the cluster, although the lower bandwidth afforded to this cluster may cause execution stalls and other example issues. For instance, turning to the simplified block diagram 600 of FIG. 6, an example is shown of example DPU clusters (e.g., 605a-d) mapped connected to example CMX slices (e.g., 610a-d). In some instances, as introduced above, individual clusters may be assigned preferential access to a respective one of the CMX slices, among other example implementations.

In systems employing accelerators such as illustrated in the example of FIG. 6, in order to achieve maximum performance (e.g., 8.2 TOPs/sec @800 MHz) all the DPUs should be fully utilized at all times to achieve maximum performance (e.g., an idle cycle may cost 5120 MAC operations). To achieve this, input activations and weights should be ready when a new layer is ready to be executed. This means that (1) layer weights should be loaded from DDR to CMX during the previous layer execution and (2) a layer output activation should be stored in the CMX in order to avoid unnecessary DMA transfers to DDR.

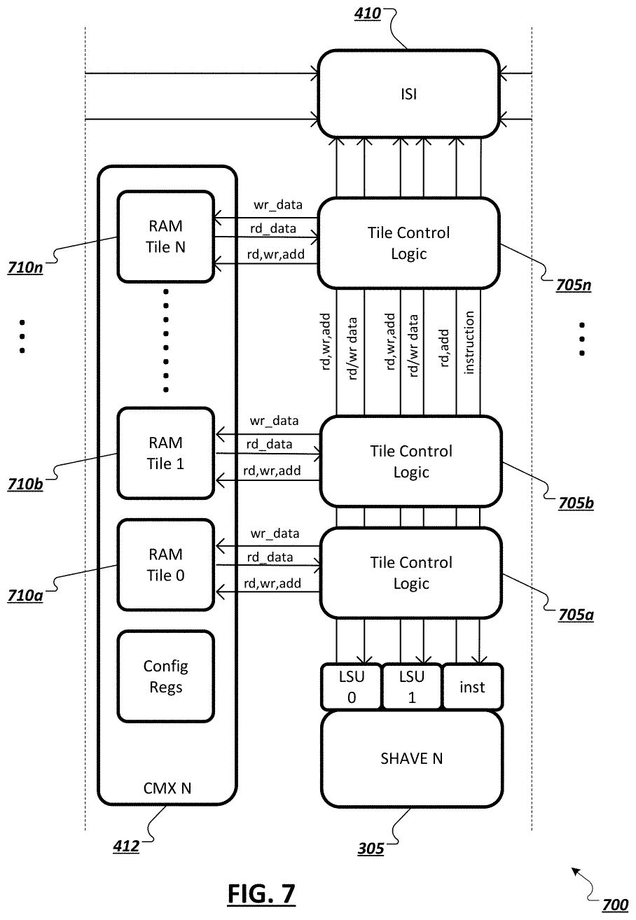

FIG. 7 is a simplified block diagram 700 illustrating a section of an example machine learning device (such as in the previous examples) in accordance with some embodiments. The section includes a single processor 305 (e.g., a SHAVE processor), a memory slice 412 associated with the single processor 305, interconnection system 410 that couples the processor 305 to one or more of the other memory slices of the machine learning device, and control logic (e.g., 705a-n) for arbitrating communication between a tile in the memory slice 412 and processors (e.g., 305). As illustrated in the example of FIG. 7, the processor 305 can be configured to directly access the memory slice 412 associated with the processor 305, while the processor 305 can access other memory slices (not shown) via the interconnection system 410. In some embodiments, each memory slice (e.g., 412) can include a plurality of RAM tiles or physical RAM blocks (e.g., 710a-n). For instance, a memory slice 412n having the size of 128 kB can include four 32 kB single-ported RAM tiles (e.g., physical RAM elements) organized as 4 k×32-bit words. In some embodiments, a tile can also be referred to as a logical RAM block. In some embodiment, a tile can include a single ported complementary metal-oxide-semiconductor (CMOS) RAM. The advantage of a single ported CMOS RAM is that it is generally available in most semiconductor processes. In other embodiments, a memory tile (e.g., 710a-n) can include a multi-ported CMOS RAM.

In some embodiments, each memory tile (e.g., 710a-n) can be associated with a respective tile control logic (e.g., 705a-n). The tile control logic (e.g., 705a-n) may be configured to receive requests from processors (e.g., 305) and provides access to the individual read and write-ports of the associated tile (e.g., 710a-n). For example, when a processing element (e.g., 305) wants to access data in a RAM tile (e.g., 710a), before the processing element 305 sends the memory data request to the RAM tile 710a directly, the processing element 305 can send a memory access request to the tile control logic 705a associated with the RAM tile 710a. The memory access request can include a memory address of data requested by the processing element 305. Subsequently, the tile control logic 705a can analyze the memory access request and determine whether the processing element 305 can access the requested memory. If the processing element 305 can access the requested memory, the tile control logic 705a can send an access grant message to the processing element 305, and subsequently, the processing element 305 can send a memory data request to the RAM tile 710a. As there is potential for simultaneous access by multiple processing elements, in some embodiments, the tile control logic (e.g., 705a-n) can include a clash detector, which is configured to detect an instance in which two or more processing elements, such as a processor or an accelerator, attempt to access any one of the tiles in a memory slice. The clash detector can monitor access to each tile (e.g., 710a-n) for an attempted simultaneous access. The clash detector can be configured to report to the runtime scheduler that an access clash has occurred and needs to be resolved, among other example features.

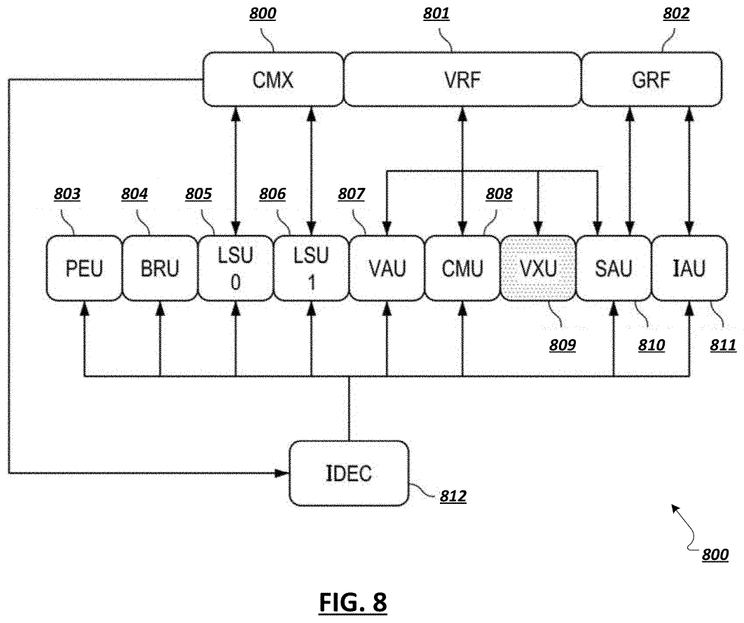

FIG. 8 shows a simplified block diagram illustrating an example implementation of a multislot vector processor 305 (e.g., a very long instruction word (VLIW) vector processor), such as a SHAVE processor, in accordance with some embodiments. In this example the vector processor may include multiple (e.g., 9) functional units (e.g., 803-811), which may be fed by a multi-ported memory system 800, backed up by a vector register file (VRF) 801 and general register file (GRF) 802. The processor contains an instruction decoder (IDEC) 812, which decodes instructions and generates control signals which control the functional units 803-811. The functional units 803-811 are the predicated execution unit (PEU) 803, branch and repeat unit (BRU) 804, load store port units (e.g., LSU0 805 and LSU1 806), a vector arithmetic unit (VAU) 807, scalar arithmetic unit (SAU) 810, compare and move unit (CMU) 808, integer arithmetic unit (IAU) 811, and a volumetric acceleration unit (VXU) 809. In this particular implementation, the VXU 809 may accelerate operations on volumetric data, including both storage/retrieval operations, logical operations, and arithmetic operations. While the VXU circuitry 809 is shown in the example of FIG. 8 as a unitary component, it should be appreciated that the functionality of the VXU (as well as an of the other functional units 803-811) may be distributed among multiple circuitry. Further, in some implementations, the functionality of the VXU 809 may be distributed, in some implementations, within one or more of the other functional units (e.g., 803-808, 810, 811) of the processor, among other example implementations

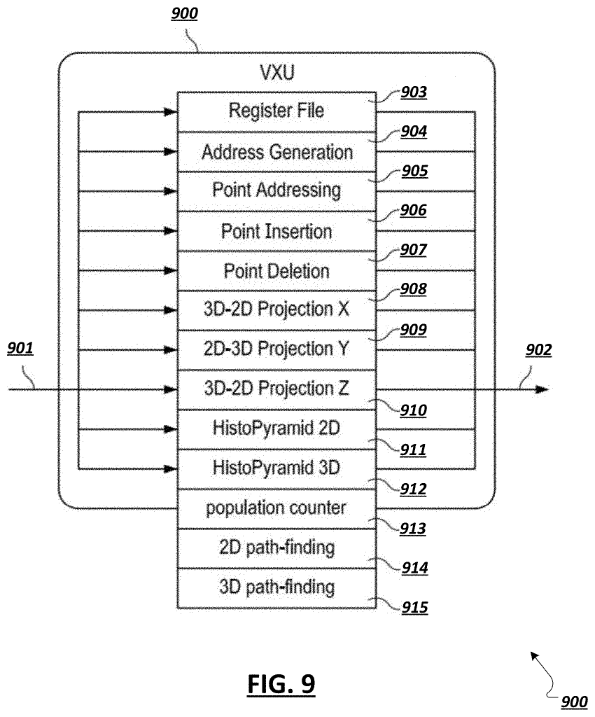

FIG. 9 is a simplified block diagram illustrating an example implementation of a VXU 900 in accordance with some embodiments. For instance, VXU 900 may provide at least one 64-bit input port 901 to accept inputs from either the vector register file or general register file. This input may be connected to a plurality of functional units including a register file 903, address generator 904, point addressing logic 905, point insertion logic 906, point deletion logic 907, 3D to 2D projection logic in X dimension 908, 3D to 2D projection logic in Y dimension 909, 3D to 2D projection logic in X dimension 910, 2D histogram pyramid generator 911, 3D histopyramid generator 912, population counter 913, 2D path-finding logic 914, 3D path-finding logic 915 and possibly additional functional units to operate on 64-bit unsigned integer volumetric bitmaps. The output from the block 902 can be written back to either the vector register file VRF or general register file GRF register files, among other example features.

Traditional compilers may be unable to generate a compiled binary for machine learning applications that effectively and efficiently utilizes the architectural elements of an example machine learning device, such as discussed in the examples of FIGS. 2-8. Further, in such machine learning devices, the compiled binary for the device may be serialized data and not machine code. Among other metadata, the compiled binary may specify the specific schedule in which operations are to be executed and the assigned memory locations to store tensors for use in subsequent operations thus optimizing inference (frames per second) and power performance, among other aspects of the machine learning device architecture.

Some machine-learning-specific compilers have been developed, but such compilers are also not without their failings. For instance, TensorFlow™'s Accelerated Linear Algebra™ (XLA compiler), for example, provides methods to retarget TensorFlow to non-CPU like hardware with or without an LLVM backend. However, such compilers may be limited in their applicability. For instance, the Google™ Tensor Processing Unit (TPU) has been developed as a custom ASIC specifically tailored to the TensorFlow framework. While existing machine-learning compilers may be used as the basis for non-TPU applications, such as by implementing a new backend to the XLA compiler (among other similar examples), such solutions have a number of example disadvantages and challenges. For instance, crafting a custom backend requires significant engineering time and resources, with the results in the hardware still limited by being tightly coupled with TensorFlow models. Further, XLA emits a vectorized LLVM intermediate representation (IR) for some nodes (such as dot), and relies on the LLVM vectorize for other nodes, however, this may not be compatible with some machine learning device architectures, such as the architectures described in the examples above. In some implementation, an example VPU, such as discussed above, may require an abstract compute resource interface to expose at compile time to identify the compute resource(s) that are available on the target VPU.

As another example shortcoming, an XLA compiler (and other existing machine learning compilers) may not be able to guarantee optimal inference performance due to its assumption of a non-abstract memory type's interface, which may result in a non-optimal balance of in memory data locality thus reducing the full exploitation of compute parallelism. In some machine learning devices, an abstract memory type interface may be implemented. Further, to ensure full exploitation of compute parallelism, an abstract software-based memory allocation mechanism may be required that enables an application programming interface (API) for specifying which compiler algorithms to use to manage the allocation of memory. One such example is specifying that the compiler uses acyclic graph coloring memory allocation. As yet another example issue, TensorFlow, and other existing machine learning frameworks may be designed to operate using standard CPU/GPU-like memory architectures and not optimized memory architectures, such as discussed in the example memory architectures discussed in the example machine learning device systems above, among other example issues. Further, in hardware architectures employing hardware barrier resources, such as introduced above, traditional compiler implementations may not be aware of such hardware barriers or their implementations details and provide no mechanisms for their control. Further, the details of the respective runtime environments of various machine learning devices may also be unknown to traditional compilers, among other example shortcomings.

In one example, an improved compiler 105 may be implemented with a modular modern compiler infrastructure. In some cases, at least some of the features of the compiler 105 may be based on LLVM principles. As discussed above, utilizing TensorFlow-based compilers in some machine learning hardware device architectures and operators may be difficult/expensive and not scalable due to the limitations of developing a custom backend. An improved compiler, such as discussed can address these and other example issues.

In some implementations, an improved compiler may be configured to consume a machine learning framework's (e.g., TensorFlow, Caffe™, etc.) representation (e.g., 110) of a Deep Neural Network (DNN), adapt and optimize it for a selected target (e.g., 125) and produce a binary executable (e.g., 150) corresponding to the selected target hardware 125 in a way that allows for compile time target specific optimizations. Further, implementation of an example improved compiler may also implement a task synchronization management scheme compatible with target machine learning devices provided with hardware barrier resources, thereby supporting the generation of binary executables, which make use of such resources, among other example benefits.

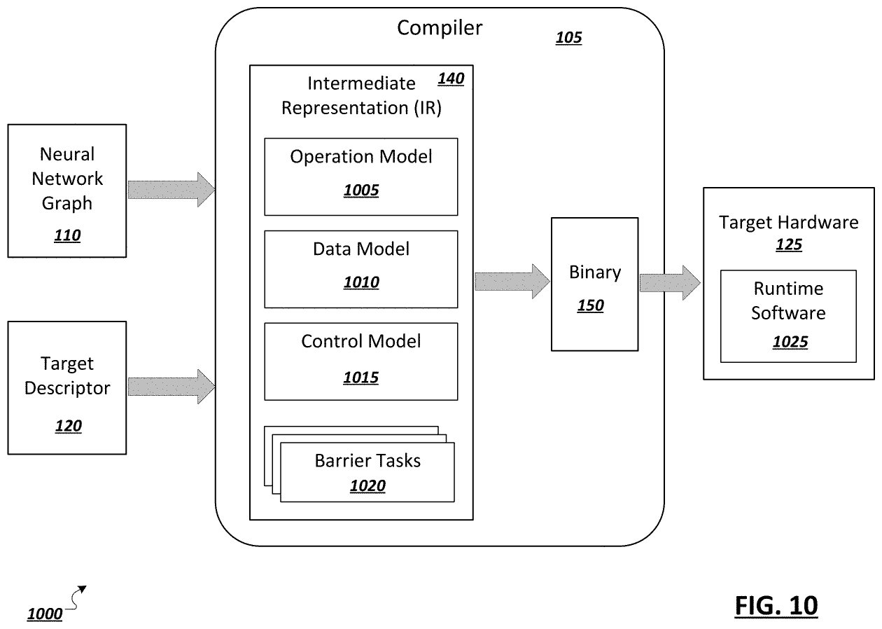

FIG. 10 is a simplified block diagram 1000 illustrating the generation of an example serialized binary 150 from a graph data structure 110 defining a trained neural network model for use in deep learning applications. The binary 150 may be generated to optimize the resources available at a particular target machine learning hardware device (e.g., 125). To produce such a binary 150, an improved compiler 105 may be provided that is implemented to optimize performance of deep learning applications. In some implementations, the compiler 105 may access the neural network model 110, together with information (e.g., target descriptor file 120) concerning the application and the target hardware 125 and generate an improved intermediate representation (IR) 140 from which the binary 150 is to be generated. In one example implementation, the intermediate representation 140 may be composed of a set of sub-models. In the particular example of FIG. 10, the models of the intermediate representation 140 may include an operator model 1005, a data model 1010, and a control model 1015. The intermediate representation 140 may also be provided with data (e.g., structural data 1020) describing attributes of the target hardware device (e.g., as extracted from an example target descriptor file 120), among other example sub-models and information.

When a neural network model is consumed from the front-end of an example compiler (e.g., 105), an intermediate representation (IR) 140 may be generated as discussed above. In one example, the IR 140 may be constructed by the compiler by parsing the neural network model 110 to identify the respective operations and data flow used to implement the neural network. Further, the compiler 105 may identify, from a target descriptor file 120, the memory and compute resources (and other resources (e.g., communication resources)) available on the target hardware device (e.g., and store this information in the IR (e.g., in structural model 1020)). A set of sub-models (e.g., 1005, 1010, 1015) may be generated and encapsulated within the intermediate representation 140 to provide a configurable representation of a mathematical structure (e.g., the computation model of the intermediate representation) of the neural network described in graph 110, for instance, in the form of one or more computation graphs from which a binary may be constructed, among other example implementations. The sub-models may each provide distinct views, but refer to the same underlying structure, the computation model of the intermediate representation. This may allow the overall complexity of the intermediate representation to be simplified to address compilation issues in isolation while sustaining the coherence of the logical space, which allows efficient processing of mutual relations between all types of entities considered.

In some implementations, a target descriptor file 120, describing a particular machine learning device (e.g., 125), may identify to the compiler 105 that the machine learning device 125 includes a set of hardware barrier devices and may additionally provide information detailing attributes of these hardware barrier resources. In some implementations, a compiler 105 may utilize hardware barrier information for a target machine learning device and generate one or more hardware barrier tasks 1020 to generate a binary 150 that utilizes the hardware barrier resources to realize optimized scheduling using these resources. In some implementations, the barrier tasks 1020 may be generated in association with one or more compilation passes and inserted in a graph of the intermediate representation 140, among other example implementations.

In some instances, creating optimal execution schedules for workloads running on a particular machine learning device may present several problems for the compiler 105 generating these schedules. For instance, a successful schedule may satisfy goals and conditions such as: schedules should utilize the target machine learning device's specific hardware innovations intended to accelerate task synchronization; schedules should be compatible with the runtime software methods (e.g., 1025) for controlling/synchronizing the tasks; schedules should guarantee that all tasks can run without exceeding hardware resource limitations; schedules should optimize execution time and/or power-consumption and/or memory utilization and/or communication overhead; and compilation time should be acceptable for the customer/application, among other example objectives.

Among other example features, an improved compiler may support the creation and use of barrier tasks during a compilation process to leverage hardware barrier resources of the target hardware, and thereby realize at least some of the goals above. While simple compiler scheduling may schedule all tasks to run consecutively, with no parallelism, such scheduling may result in unacceptably long run times and not fully utilize the available hardware accelerator resources of the target device, among other example disadvantages. Synthesizing an optimal schedule is one of the compilers most difficult objective. In addition to coming up with an optimal schedule, the compiler should also enable the runtime hardware/software (e.g., 1025) to synchronize the execution of tasks which may overlap in time. Hardware barriers and binaries generated to effectively utilize these hardware barrier resources may assist in more effectively managing such objectives.

In some implementations, hardware barrier resources and runtime software 1025 of sophisticated machine learning devices may implement a first-in, first-out (FIFO)-based, real-time, dynamic task scheduling architecture. Such architectures may support dynamic allocation of the computation resources at run-time. Dynamic scheduling of compute tasks means that tasks at the output of the ready-queue can be allocated to whichever appropriate computation resource(s) is/are available at the time. For instance, example runtime software 1025 may also allow for both dynamic and static allocation of the hardware barrier resources of the device 125. For instance, in static barrier allocation mode, an improved compiler (e.g., 105) may be provided with logic to assign specific hardware barriers to tasks identified for implementing a given neural network. In some implementations, such as illustrated in FIG. 10, the compiler 105 may create and insert barrier task objects 1020 to facilitate in the effective assignment of hardware barriers to tasks (e.g., identified in one or more of the intermediate representation models (e.g., 1005, 1015, etc.)). In other instances, a compiler may additionally or alternatively support dynamic hardware barrier assignment mode.

In a dynamic barrier assignment, the compiler 105 may identify and determine opportunities to use hardware barriers of a target device (e.g., 125) and use barrier task objects (e.g., 1020) to define virtual barrier assignments to various tasks used to implement the neural network in the resulting binary 150. In dynamic barrier assignment, runtime software 1025 of example target hardware 125 may execute the binary 150 and be responsible for assigning specific physical hardware barriers to the tasks (corresponding to the virtual barrier assignments specified in the binary 150), among other example implementations. For instance, in dynamic barrier assignment, the compiler 105 may identify that hardware barriers are to be used within a control flow and assign indices constituting virtual hardware barriers. The runtime software has liberty to use any one of the available hardware barriers it determines best (during runtime) to implement a given virtual barrier defined by the compiler, but may be restricted in only assigning one hardware barrier at a time to each virtual barrier index identified by the compiler. For instance, when a hardware barrier is used to implement a given virtual barrier, it may be released following completion of a corresponding barrier control task, such that the same hardware barrier may be used to later implement another, different virtual barrier defined by the compiler. Likewise, different hardware barriers resources may be utilized by the runtime software to implement the same virtual barrier at different points in the control flow, among other examples. Further, in multiprocessing implementations, a same hardware barrier may even be used to implement virtual barrier in two different processes (e.g., two different inferences) being executed concurrently by the target machine learning device, among other examples.

To support either static or dynamic barrier allocation modes, an improved compiler 105 provides the runtime software 1025 with particular data (e.g., in binary 150) allowing control and allocation of the compute tasks and hardware barriers. Indeed, in some implementations, target machine learning devices may support multiprocessing, allowing multiple neural network inferences (e.g., using the same or different neural network model) to be running simultaneously on the machine learning device, further complicating resource allocation and management by the runtime software 1025, including assignment of hardware barriers of the target device 125, among other example issues. Accordingly, an improved compiler 105 may support a variety of different allocation algorithms to assist in preparing schedules tuned to the various user and/or application requirements and optimizing for compile time, program execution time, and/or program power consumption or image throughput (frames per second). Such features of the compiler 105 may allow the compiler 105 to generate binaries (e.g., 150) to implement schedule that are flexible to support multiple complex optimizations for a variety of different target machine learning devices (e.g., 125), among other example features.

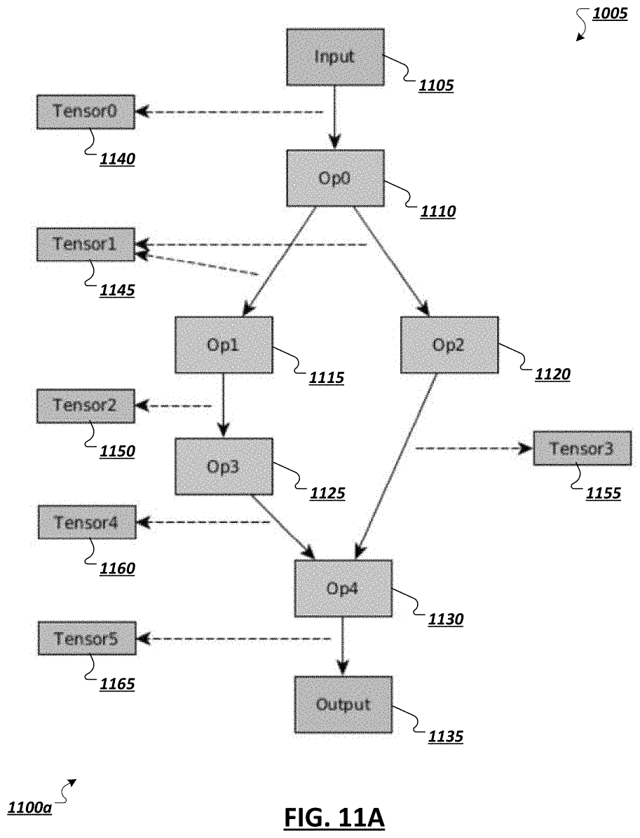

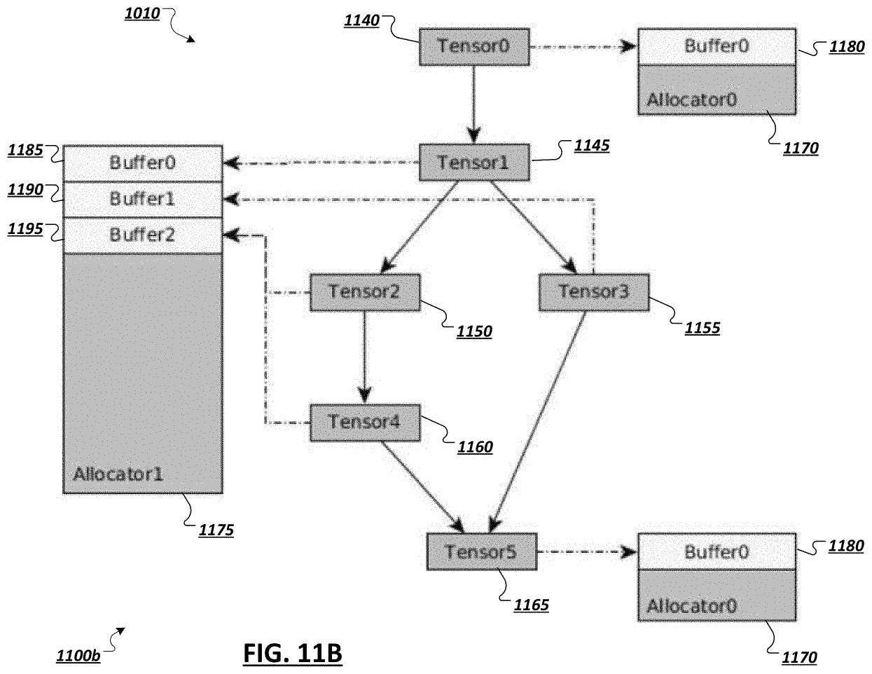

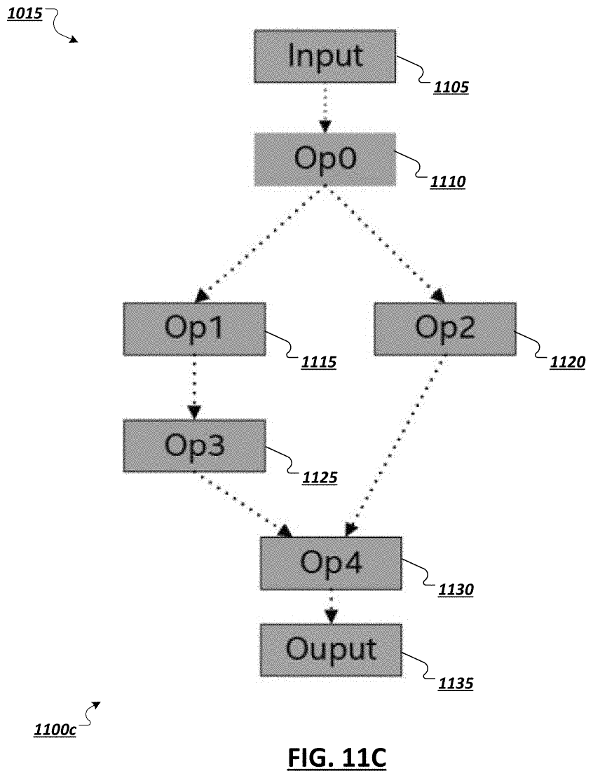

FIG. 11A is a simplified block diagram representing an example operator model 1005 in accordance with at least some embodiments. In this example (and the corresponding examples discussed in connection with FIGS. 11B-11C below), an example neural network is defined and described in an example graph data structure. The improved compiler may accept, as inputs, the graph data structure, together with a target descriptor describing attributes of a particular target device, and a compilation descriptor describing principles and compilation passes to be performed in connection with the compilation of the neural network into a binary for consumption by the target device. In this (simplified) example of a neural network, an input 1105 is to be received at the neural network and a collection of operations (e.g., 1110, 1115, 1120, 1125, 1130) are performed to implement the neural network layers (e.g., through multiply-accumulate (MACC) operations, perform activation functions, etc.) and generate an output 1135 (e.g., inference result, classification result, feature vector, etc.).

In some implementations, the operator model 1005 provides a configurable representation of a mathematical structure of the neural network (e.g., DNN) in the form of a computation graph. The operator model graph, in some implementations, may identify and model mathematical operations (or, simply, “operations”) serving as the building blocks of the neural network; tensors representing the products (e.g., multidimensional arrays) of the operations; and the data flows of the neural network, representing the data dependencies between operations that refer to tensors. The operator model 1005 may identify each of the operations (e.g., 1105-1135) and tensors (e.g., 1140, 1145, 1150, 1155, 1160, 1165) within this data flow. The tensors represent an anticipated result of at least one of the operations of the neural network. Accordingly, tensors may be associated with corresponding operations (e.g., operations (e.g., 1110) that will generate the corresponding tensor (e.g., 1150) as a result). In some implementations, an operator model (e.g., 1005) may be generated by mapping each of the nodes in the neural network graph 110 to a respective operation (e.g., 1105-1135) and defining a tensor for each edge in the neural network graph 110.

FIG. 11B is a simplified block diagram representing an example data model 1010 in accordance with at least some embodiments. A data model (e.g., 1010) may serve as a resource sub-model of the intermediate representation to model the manageable resources available in a target machine learning device, which may be used to implement the particular neural network (e.g., modeled by graph 110). Such resources may include memory resources representing the various types of memory of defined capacity used for the storage of tensors and accessible by various types of computation resources on the device, and computation (or “compute”) resources representing the hardware modules of the machine learning device that enable computation and processing of data or control of the execution. Resource sub-models of the intermediate representation may enable both types of manageable resources to have dedicated view that allows the compiler to generate an executable to efficiently and optimally access and manipulate them. In the case of a memory resources, the data model 1010 may be provided.

In the example of FIG. 11B, a data model 1010 may include a graph to represent the tensors (e.g., 1140-1165) determined for the neural network and may additional include memory allocator objects (e.g., 1170, 1175) for each memory resource of the target machine learning device. In some implementations, a target descriptor 120 file (e.g., implemented as JSON file) may be consumed by the compiler 105 and the available memory resources of the target machine (e.g., one or more off-chip memory blocks, one or a set of scratchpad memory blocks, among other memory resources) may be identified, and corresponding memory allocator objects may be instantiated. In the particular example of FIG. 11B, two memory resources have been detected in the particular target machine learning hardware, such as a local scratchpad memory resource and an off-chip DDR resource, among other potential examples. Accordingly, in the example of FIG. 11B, the compiler may instantiate two corresponding memory allocator objects (e.g., 1170 and 1175) respectively for each of the two identified memory resources of the target.

In some implementations, a memory allocator object may define a set of attributes to be determined for the corresponding memory resource as well as a set of methods, which may be called (e.g., by the compiler) to determine values for the attributes and populate these values in the memory allocator object. Memory allocator objects may enable a compiler capable of a flexible memory management approach for optimal inference performance in deep neural network applications. Each memory allocator object may manage the allocation of data buffers (e.g., 1180, 1185, 1190, 1195) for its respective type of memory resource (and memory region specified in the target descriptor file). This enables the precise location of every piece of data at any given stage in the execution process to be known at compilation time. This specialized memory management approach in the compiler, facilitated through these memory allocator objects, may serve as a key enabler for an improved compiler to generate executables that enable target hardware to achieve better inference performance than in traditional implementations, among other example benefits.

FIG. 11C is a simplified block diagram 1100c representing an example control model 1015 in accordance with at least some embodiments. The control model 1015 may also implement a portion of the resource sub-model of the intermediate representation. Specifically, the control model 1015 may be used to model computation resources. The control model 1015 may model the order and dependencies of the collection of operations determined to implement the neural network (e.g., in connection with the generation of the operator model). The ordering may be determined, not only from the nodes of the neural network graph, but also from the attributes and resource constraints of the target hardware system, as identified in a target descriptor file.

FIG. 11C shows a simplified example of a control model 1015 (corresponding to the example operator and data models of FIGS. 11A-11B). In this particular example, the hardware resource constraints of the identified example machine learning device are capable of facilitating the ordering and dependencies as natively described in the neural network graph. For instance, control model 1015 may define that operation 1110 is to begin after (and is dependent on) completion of operation 1105, that operation 1115 is to begin after (and is dependent on) completion of operation 1110, and that operations 1120 and 1125 are to begin after (and are each dependent on) completion of operation 1115. As operation 1125 is in a parallel branch as operations 1120 and 1130, operation 1125 is not dependent on operations 1120 or 1130 and operations 1120 and 1130 may be performed before, after, or in parallel with operation 1125, and so on. In other implementations, either due to the complexity and demands of the operations determined to implement a given neural network and/or due to the resource limitations of the selected target machine learning device (e.g., limited memory, compute, or communications resources), an example control model (e.g., 1015) may be developed (e.g., based on one or more compilation passes and information in the corresponding target descriptor file), which considers not only the native ordering expressed in the neural network graph, but also reflects the hardware resource limitations of the target hardware. For instance, due to resource constraints, additional dependencies may be determined for implementation of a neural network on particular target hardware, and these additional dependencies may also be described and modeled in the control model generated for such examples.

An example compiler utilizes the sub-models of the intermediate representation to perform a collection of compilation passes to generate an executable tuned to particular target hardware. Depending on the compilation pass, a particular one of the intermediate representation sub-models may be selected and used to perform the compilation pass. In general, the compilation process is divided into compilation passes that are functions over the intermediate representation's computation model. However, it should be appreciated that the scope of a single compilation pass is not restricted, but is usually oriented on solving an isolated task, such as assigning static populated tensor to constant-like memory or replacing sub-graph of operations with more efficient equivalents, among other examples. In some implementations, this compilation process transforms a generic, target agnostic entry form of the neural network graph model into representation appropriate for the target hardware. As part of that process, the intermediate representation is used to assign computation resources to operations (simultaneously with replacement of generic operations with target defined equivalents) and memory resource to tensors. Further, the control model may further enhance the intermediate representation to define the flow of execution, for instance, to enable a parallel execution of certain part of a deep neural network, among other example features.

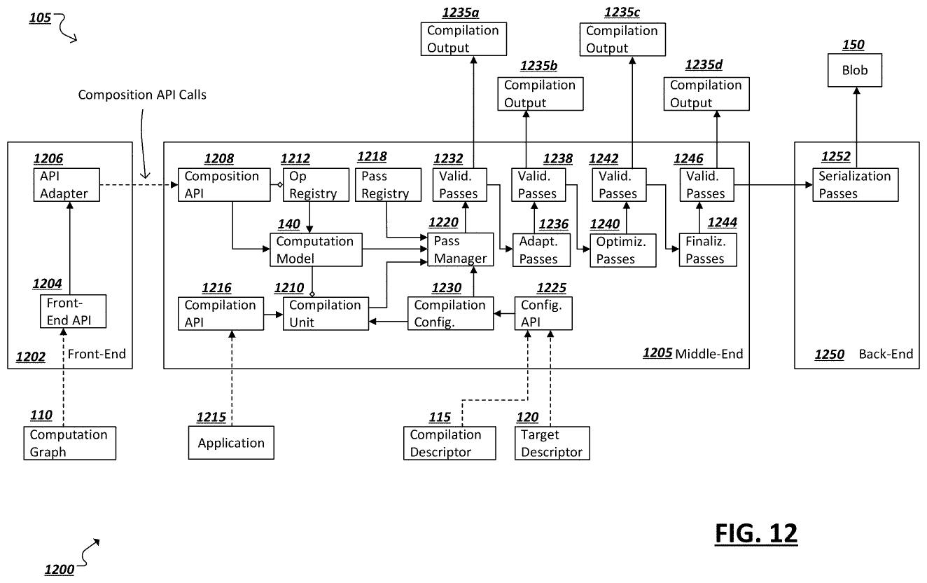

Turning to FIG. 12, a simplified block diagram 1200 is shown illustrating components and functionality of an example compiler 105, such as described in the improved embodiments discussed herein. The compiler 105, in this example, may include a front end 1202, a middle-end 1205, and a back end 1250. A compilation graph 110 describing a particular trained neural network may be received, in some implementations, at the front end (e.g., through front-end API 1204). The graph 110, in some instances, may be generated according to an open source platform (e.g., TensorFlow, Caffe, etc.). The front end may consume and parse the graph 110 and generate composition API calls (e.g., from API adapter 1206 to a composition API 1208) and initiate generation of an executable binary (e.g., 150) for the particular neural network using the compiler 105.

In some implementations, a composition API may be provided, which is configured to generate an intermediate representation, or “computation model” 140, for the particular neural network. In some instances, an operation registry 1212 may be provided to define, within the compiler, a number of operations of which the compiler 105 is familiar and that may correspond to nodes in example neural network graphs. The operation registry 1212 may be used to define how the compiler is to handle allocation of hardware resources in order to enable performance of the particular operation. In some cases, the operation registry 1212 may include a collection of operation definitions associated with the implementation of deep learning models.

In some instances, an example compiler may be provided, which includes a compilation API 1216 capable of interfacing with one or more external applications (e.g., 1215) (or, in some cases, an application provided in a suite of deep learning integrated development environment tools), where the application is configured to enable users to author and generate a graph of a particular neural network model, among other example implementations. In either instance, a corresponding intermediate representation may be generated for the graph. In some implementations, the intermediate representation may include an operator model, a data model (with memory allocators), and a control model, which may be used in connection with the performance of various compilation passes, such as discussed herein.

In some implementations, in addition to accepting a neural network graph at the compiler 105, additional inputs may be received to customize the configuration of the compiler 105 for a particular compilation project. For instance, as introduced above, a compilation descriptor file 115 may be provided as an input to indicate a set of supported compilation passes to be performed by the compiler in connection with the generation of particular code 150 to implement the particular neural network. The compilation descriptor may define a list of passes to be executed during the compilation. The entries on such a list and their order may be specific for both target platform and compilation objective, for instance to optimize for performance or optimize for size. Additionally, a target descriptor file 120 may be provided as input to specify attributes of a particular neural network computing device that is to implement the neural network and for which the executable code 150 is to be tuned or optimized. In some implementations, a configuration API 1225 may receive the compilation descriptor 115 and target descriptor 120 and may extract information from the files 115, 120 to generate a compilation configuration 130, which may be used by a compilation unit 1210 and pass manager 1220 (or other components) responsible for orchestrating the compilation.

An example compilation unit (e.g., 1210) may be configured to manage the sequence of the compiler's 105 operation. The compilation unit 1210 may utilize the computation model 140 and compilation configuration 1230 to drive a particular compilation of a neural network to be tuned to a particular machine learning device. For instance, the compilation descriptor 115 may be parsed to determine a particular collection of compilation passes to perform. For instance, the compilation descriptor 115 may include a listing of compilation passes (e.g., selected by a user engineer or by a system) or may name a particular pre-defined collection, or package, of compilation passes, which the compiler may 105 recognize to determine which sub-set of supported compilation passes to perform in connection with a particular compilation project, among other example implementations. The compilation descriptor 115 may also define an order or dependencies of one or more compilation passes and the conditions for performing one or more the compilation passes, among other example information. A pass registry 1218 may be maintained in the compiler 105 and include logic to be selected and executed by the compiler to perform any one of a set of compilation passes supported by the compiler and listed in the compilation descriptor 115. In some implementations, the pass registry 1218 may be extendable, in that new and improved compilation passes may be added to or replace compilation passes included in the set of compilation passes of the pass registry 1218. A simplified a representation of an example compilation descriptor is provided as an illustrative example below:

```
{
  “initialize”: {
    “Singular”: [
      {
        “Number_of_DPUs” : 5,
        “Number_of_Clusters” : 4,
        “mpe_mode” : “Matrix”,
      },
      “ComputeMemory”,
      “AssignUniqueOpld”,
    ]
  },
  “adapt”: {
    “Singular”: [
      “FuseBatchNorm”,
      “FuseBias”,
      “FuseRelu”,
      “FuseScale”,
    ]
  },
  “custom_adapt”:{
    “Singular”: [
      “StoreWorkloadStrategy”,
      “ConvertOpsToTasks”,
      “ComputeTensorsQuantParams”,
      “OrderConversion”,
      “AlignTaskWeights”,
      “GenerateSparsityMaps”,
      “GenerateWeightsTables”,
    ]
  },
  “dma”: {
    “Singular”: [
      “AddInitialAndFinalDMATask”,
      “AddMemoryDeallocationTasks”,
    ]
  },
  “control_flows”:{
    “Singular”: [
      “DmaControlFlows”,
      “InputOutputControlFlows”,
        “TransitiveReduction”,
    ]
  },
  “finalize”: {
    “Singular”: [
      “MaxTopologicalCutAndPartialSerialisation”,
        “GenerateDPUWorkloads”,
      “ArrangeCustomExecution”,
      “AllocateInputOutputTensorsCustom”,
      “AllocatePopulatedTensorsCustom”,
      “AllocateUnpopulatedTensorsCustom”,
      “TensorGraphColoring”,
      “RemoveDeallocationTasks”,
      “AddBarrierRefs”,
      “UpdateBarrierProducerConsumerCounts”,
      “PopulateWeightsTables”,
    ]
  },
  “validate”: {
    “Singular”: [
      “CheckTensors”
    ]
  },
  “serialize”: {
    “Singular”: [
      {
        “name”: “GenerateBinary”,
        “output”: “output/mcm.blob”
      },
    ]
  },
  “root”: {
    “Singular”: [
      “initialize”,
      “validate”,
      “adapt”,
      “custom_adapt”,
      “dma”,
      “control_flows”,
      “finalize”,
      “serialize”
    ],
    “Recurrent”:[
      “validate”
    ]
  }
}
```

In some implementations, a pass manager 1220 may interface with the compilation unit 1210 and initiate and orchestrate a series of compilation passes using the intermediate representation 140. (e.g., in accordance with a listing of compilation passes named in the compilation descriptor 115 and provided through the compilation configuration 130). In some implementation, the compilation passes may begin with one or more initial validation passes 1232 to validate the neural network graph for correctness before proceeding to a next stage of compilation passes. A corresponding validation pass (e.g., 1238, 1242, 1246) may be performed following the completion of a stage of (one or multiple) compilation passes (e.g., 1236, 1240, 1244). After each validation pass, a respective compilation output (e.g., 1235a-d) may be generated to document the results of the validation pass and provide system engineers and debuggers data to evaluate the progress and performance of the compilations. In some implementations, the compilation output data (e.g., 1235a-d) may include or be rendered into a graphical representation of the graph, as evaluated in the validation passes (e.g., and annotated to indicate any issues detected during the validation pass as well as identifying nodes and edges associated with these issues, among other example information).

In one example, compilation passes may be grouped into sets of compilation passes (e.g., of a particular type or category). Compilation passes may result in transformed versions of the intermediate representation graph, with validation passes confirming that these transformed, modified IR graphs are valid. In some instances, a compilation descriptor 120 may identify each of these groups of passes and specify the individual passes to be performed in each group or compilation stage. For instance, in one example, a set of one or more adaptation compilation passes 1236 may be defined and performed before other categories of compilation passes (e.g., optimization passes 1240 and/or finalization passes 1244, etc.). Adaptation passes 1236 may be compilation passes, which identify opportunities (independent of the target hardware) to modify the neural network graph itself and potentially simplify and optimize operation and data flows associated with the neural network, such as through fusion compilation passes (e.g., to combine two operations into a single operation) or replacement compilation passes (e.g., replace operations with functionally equivalent and more efficient or adaptable replacement operations), among other examples. Such compilation passes may identify hardware-agnostic opportunities, rooted in the underlying mathematics of the operations to be performed to implement the neural network, to generate a pared, more efficient version of the neural network (and reflect these modifications in a transformation of the intermediate representation graph).

Upon performing adaptation passes 1236 to perform hardware-agnostic optimizations of the underlying neural network graph, one or more corresponding validation passes (e.g., 1235b) to determine whether changes made to the graph through the adaptation passes 1236 result in errors, inconsistencies, conflicts, or other issues within the graph. Should a transformed version of the intermediate representation fail a validation pass, the compilation process may be interrupted (e.g., to allow for debugging) or terminated. A successful validation pass may enable further compilation pass stages (e.g., 1236, 1240, 1244, etc.) to proceed. Following the one or more adaptation passes 1236, the path manager 1220 may cause a set of optimization passes 1240 to be performed. Optimization passes 1240 may include compilation passes to determine the optimal computation resources of the target hardware (e.g., using an operator model of the intermediate representation) to perform each of the set of operations determined for the neural network (e.g., the pared set of operations resulting from adaptation passes 1236). Optimization passes 1240 may further include compilation passes to determine an optimized order to perform the operations (e.g., using the control model of the intermediate representation), among other examples.

Following the completion of optimization passes 1240, a further modified version of the computation model 140 may result and one or more corresponding validation passes (e.g., 1242) may be performed on the resulting model. Following successful completion of the optimization passes 1240, in some implementations, additional finalization compilation passes 1244 may be performed before generating the resulting executable 150. In some implementations, finalization passes 1244 may include compilation passes configured to optimally determine buffers for the various tensors defined in the model, as well as allocate and assign addresses to memory of the target hardware for these buffers and determine addressing of the allocated memory. Additional compilation passes may determine, based on an initial allocation of memory for the buffers, whether certain parallel data flows defined in the transformed computation graph will use more memory than is available on the target device, causing the compilation pass to potentially insert additional control edges to reduce parallel operations (e.g., accommodate memory resource limitations of the target device), among other examples. Memory allocator objects of a data model of the intermediate representation may be used during such memory allocation passes performed in finalization passes. Memory allocation passes may be performed, in some implementations, based on one or more specific memory allocation algorithms specified in the compilation descriptor 115. Further, in some implementations, the compiler may maintain temporary, context-defined states of all resources identified for particular target hardware. Such states may be stored in the form of computation stages, which allows to capture the time-variant characteristic of the computation. In particular, the stage data may be used by the compiler to ensure that no single resource is over-allocated in any moment of the execution, among other example features and benefits.

Following completion of the finalization passes 1244, a final validation pass 1246 may be performed, before sending the further modified computation model 140 to compiler backend 1250, where serialization passes 1252 are performed on the computation model 140 to generate a binary 150 capable of being executed by the target hardware to implement the neural network. The binary 150 may be a serial binary (e.g., a binary serially streamed out one byte at a time) optimized for implementing the neural network on the particular hardware device in accordance with the compilation descriptor 115 and target descriptor 120 files provided to the compiler 105.

As noted herein, a target descriptor file 120 (e.g., implemented as a JSON file or other human-readable and -editable file) may be utilized to specify the particular attributes of the hardware resources of a target machine learning device. In this manner, the improved compiler 105 may be configured to optimize a neural network executable for a wide variety of different machine learning devices and architectures, with respective target descriptor files being defined and used to configure the compiler to optimize to the specific attributes of the target device. Accordingly, different executables may be generated by the same compiler for the same neural network graph based on the respective target descriptor describing corresponding target hardware. Attributes of the target hardware may include attributes identifying the computation resources of the target hardware including identifying which computation resources of the target are capable of performing which types of operations (e.g., as understood by the compiler (from operation registry 1212)). The target descriptor file may additionally identify the various memory resources of the target hardware, including the types of memories, the size of these memories, affinities or connections between the memory blocks and computation resources, among other example information. A target descriptor 120 may additionally identify other information pertaining to the target hardware, including data types supported by the target hardware, interconnect or other communication resources of the target machine learning device, among other examples.

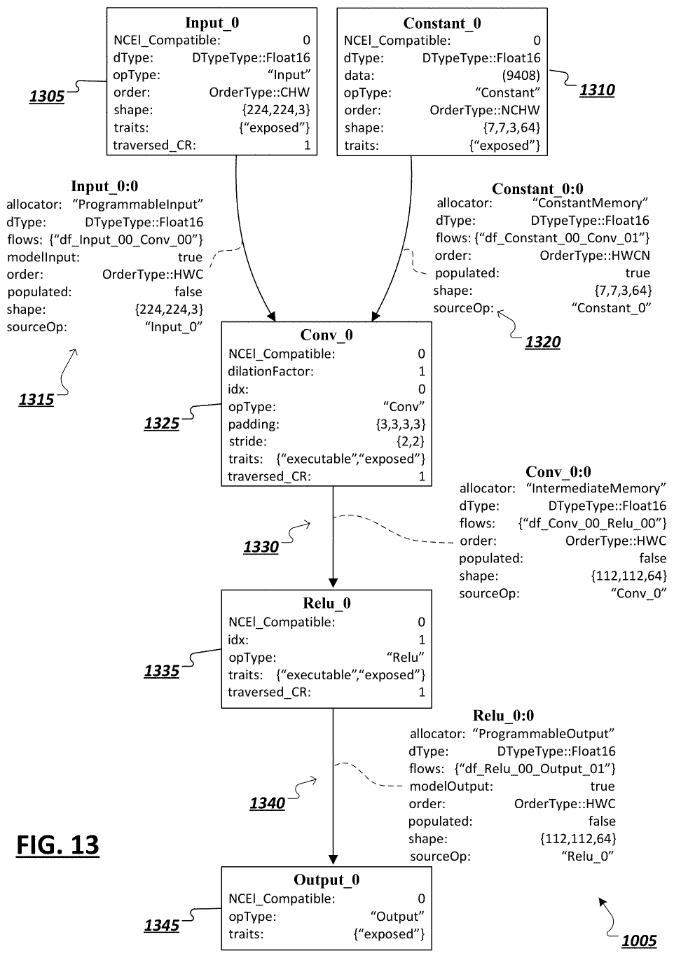

Turning to FIG. 13, a simplified block diagram 1300 is shown illustrating an example of an operator model 1005 of an intermediate representation of a particular neural network generated by an improved compiler. The example operator model 1005 may reflect the operator model as transformed by one or more compilation passes (e.g., adaptation and/or optimization passes). For instance, information concerning the operations and tensors described in the operator model 1005 may be determined and populated through such compilation passes, building on an initial version of the operator model 1005 as determined from the input neural network graph and/or target descriptor of a particular target machine learning device.

In the particular example of FIG. 13, a simplified neural network is modeled through the example operator model, the simplified neural network including two layers, a convolution layer and a ReLu layer. Two operations 1305, 1310 may be defined to correspond to accessing data to be input to the convolution layer and related convolution operation 1325. For instance, operation 1305 may be an input operation to load a sample (e.g., an image) in memory to be provided as an input to the neural network in a classification or inference. Operation 1310 may provide a constant value (e.g., the weights) to be used in a convolution with the sample loaded in operator 1305. The operator model 1005 may include fields to identify attributes of the operations (e.g., based on the type of the operation), including an identifier of the operation type. For instance, operations 1305, 1310 may each involve loading data into memory and the operator model 1005 may include attributes such as the type of the data that is to be loaded, the order in which the load is to be performed (e.g., channel→height→width (CHW)), the shape of the data (e.g., a 224×224 pixel image with 3 (e.g., RGB) channels (224×224×3)), among other example information. For operation 1310, where a constant is to be loaded, the operator model fields for the operation may identify the constants. For other operations, such as convolution operation 1325 and ReLu operation 1335, attributes for these operation types may likewise be defined and values populated using respective fields within the operator model to identify these attributes.

Continuing with the example of FIG. 13, an example operator model 1005 may also model the tensors (e.g., 1315, 1320, 1330, 1340) output by the operations. Output operations (e.g., 1345) may simply load the last generated tensor(s) into memory. An example operator model may also define fields for populating attributes determined (through one or more compilation passes) for each of the tensors. For instance, such tensor attribute fields may include fields to store attribute information such as the name of a corresponding memory allocator used to allocate memory for storage of the tensor on the target, the data type of the tensor, flows of the tensor, shape of the tensor, ordering for storage of the tensor, etc. This information may be utilized in other compilation passes (e.g., memory allocation passes) to reserve an appropriate amount of memory to store the tensor, among other example information. For instance, early compilation passes may be utilized to determine attributes of the operations and tensors (using the operator model of the intermediate representation). With this information, additional compilation passes may be performing (using the operator model and/or control model of the IR) to determine which operations are to be performed by which compute resources and in what order. With the assignment of compute resources and operation order set, together with the collection of tensor attribute information through preceding compilation passes, memory allocation passes may be performed (using a data model of the IR) to determine how best to allocate memory to enable fast and efficient use of the tensors to thereby optimize performance of the operations of the neural network by the particular target hardware.

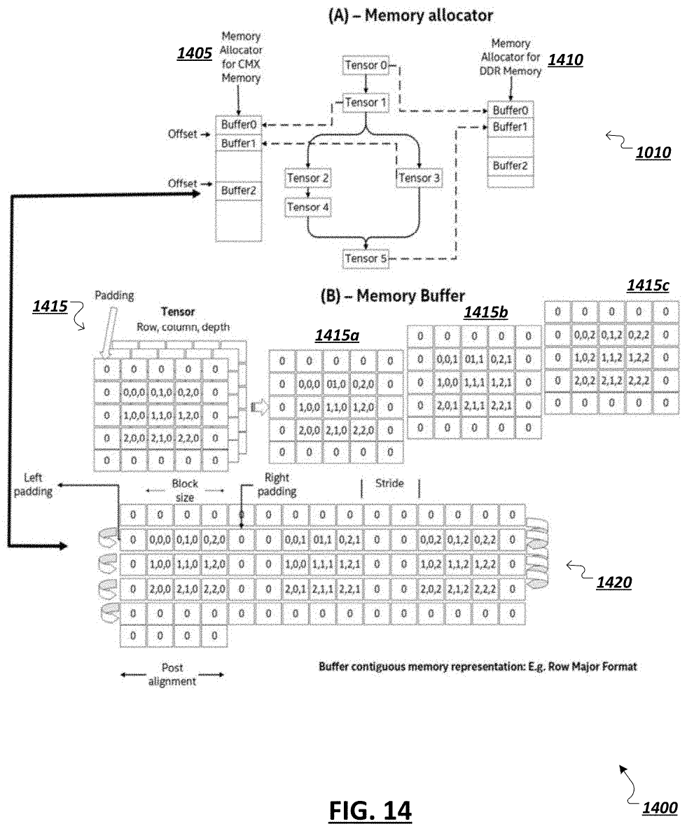

Turning to FIG. 14, a block diagram 1400 is shown illustrating an example memory allocation for an example tensor in accordance with at least some implementations. In the particular example of FIG. 14, a data model 1010 has been constructed by a compiler during generation of the intermediate representation of a particular neural network. The data model 1010 may be generated to create a number of memory allocator objects (e.g., 1405, 1410) for each of the memory resources of a target machine learning device (e.g., based on a target descriptor provided to the compiler and describing the device). In this (simplified) example, the memory resources of a particular target device include a CMX scratchpad memory resource and DDR off-chip memory. Memory allocator 1405 may be created to facilitate allocation of memory for buffers in the scratchpad memory and memory allocator 1410 may be similarly created to facilitate allocation of buffers in the off-chip memory.

The particular example of FIG. 14 illustrates allocation of memory within the scratchpad memory for a particular buffer (e.g., Buffer 2). Attributes of a particular one of the tensors 1415 (e.g., as described in the operator and/or data models of the intermediate representation) may be consulted to determine, first, which of the available memory resources would be most appropriate for use in storing the tensor. In this example, a particular tensor may be determined (e.g., through one or more compilation passes) to be used in a convolution operation by a subsequent operation performed by the same or nearby compute resource, and may thus be assigned to be stored in scratchpad memory (if available). One or more compilation passes may further utilize models of the intermediate representation to determine attributes of the tensor (e.g., its block size, padding used in the tensor, stride applied in the operation, whether the tensor (e.g., its constituent component matrices 1415a-c) should be stored in contiguous memory to optimize performance, among other example information. Determining this information can allow a size (e.g., 1420) of a buffer to be determined, which would be sufficient to store the tensor. Compilation passes may determine similar information for each of the tensors in the data model, and memory allocator objects (e.g., 1405, 1410) may extract this information and define buffers to identify the amount of memory to “reserve” or allocate for storage of each of the tensors during execution of the neural network. Memory allocation compilation passes may further act to affirmatively define address ranges in the target's memory where each buffer is to be implemented, and this information may be defined within the binary executable passed to and used by the target machine learning device.

As introduced above, an improved compiler may abstract the manageable resources of various target machine learning devices (e.g., Vision Processing Units (VPUs), TPUs, etc.), including the devices' computation resources that specific neural network operations can be executed upon and memory resources used to store tensors used in the neural network operations. For instance, target descriptors may be accepted and consumed by example compilers and the compiler may use the information within the target descriptor to flexibly tune the compilation process to the specific hardware architecture of potentially any one of multiple different devices. For instance, the target descriptor may specify which computations resources of a device are comparable performing which types of neural network operations (e.g., specifying that a convolution can be executed on either a SHAVE processor or a hardware accelerator). Example target descriptors may further specify the parameters of the operation (e.g., kernel size) that the particular computation resource can support (e.g., specifying that a particular hardware accelerator is limited to kernel sizes of 11×11). These resources are described in a Target Descriptor JSON file which is an input to the compilation.

An improved compiler may also utilize a modular software-based memory allocation approach to allocate physical memory to data structures (e.g., tensors in the graph) to specific memory regions described in the target descriptor file. This expresses how the computation resources (e.g., hardware accelerators, SHAVE processors, other processors) can access the data they need to compute on and enables code to be generated, which identifies, in optimized fashion, the precise location of every piece of data at any given stage in the execution process. Further, to ensure full exploitation of compute parallelism, the compiler may further provide an API for specifying which compiler algorithms (e.g., acyclic graph coloring memory allocation) to use to manage the allocation of memory, among other example features.

In some implementations, to enable consumption and use of target descriptors, an example compiler may be equipped with a software module integrated with the core of the compiler. Further, the compiler may provide its own API to allow users to define and modify the description of target platform as part of the compilation pipeline. For instance, the API (e.g., the DescribableTarget API) may provide methods to define memory and computation resources. For instance, the API (and target descriptor) define information for memory resources including the type of the memory resource, the size of the memory resource, byte alignment, word size, performance index, definition of tensors allocable, among other example properties. Information regarding computation resources may be defined, in the target descriptor, to include type of the computation resource, quantity or number of instances of the particular type of computation instance on the device, assignable operation types of the computation resource, translation map for the target specific operation type, restrictions of assignment because of the properties of the operation and other limitations of usage, among other example information. Further, information regarding control resources (e.g., hardware barrier resources) may be defined, in the target descriptor, to include the type of resource (e.g., hardware barrier, type of hardware barrier, or some other control resource), the quantity of the resource, hierarchical organization(s) supported for the resource (e.g., groups, process dependencies, etc.), and various limitation of usage. Similarly, a target descriptor may identify information for other hardware resources, such as communication resources, including information such as the type of communication resource, quantity, bandwidth, properties of the communication channel resource (e.g., clock speed, lane width, etc.), and other example information. Using the target descriptor, resource sub-models may be defined within intermediate representations generated by the compiler for various neural network models as part of the initialization of the compilation process.

In some implementations, the abstraction provided through a target descriptor file allows the compiler's software core to be logically decoupled from any particular target and effectively enables its easy reuse and modification. In fact, in some instances, the intermediate representation developed by the compiler may be at least partially defined during loading of the target descriptor, introducing extreme adaptability of the compiler (e.g., enabling compilation of custom configurations of machine learning devices and compilations involving purpose-built, special purpose, and proprietary machine learning devices), among other example benefits.

In some implementations, to provide an efficient mechanism to process information gathered in a particular target descriptor instance in an automated manner, while sustaining the assumption of loose restriction of its content, domain-specific meta-language may be defined for use in the target descriptor. Domain-specific meta-language may support efficient representation of complex conditional relations between structured operands, expressible in JSON format and integrated with the compiler core. Further, dynamic pass management may be supported by compilers compatible with the target descriptor, enabling custom passes to be included and controlled in the compilation.

Below is a pseudo-code representation of a portion of a simplified example target descriptor file in accordance with some generalized implementations:

```
{
  “target”: “device_name”,
  “operations”:
  {
    “Convolution”: {
      “SHAVE_PROCESSOR”:{
        “serial_description”:[
          “Attr:radixX”,
          “Attr:radixY”,
          “Attr:strideX”,
          “Attr:strideY”,
          “Attr:padX”,
          “Attr:padY”,
          “Attr:padStyle”,
          “Attr:dilation”,
        ]
      },
      “HARDWARE ACCELERATOR 1”:{
        “serial_description”:[
          “Attr:streamingMask”,
          “Attr:inputSize”,
          “Attr:outputSize”,
          “Attr:concatOffset”,
          “Attr:unloadCMX”,
          “Attr:overwriteInput”,
          “Attr:CMXSize”,
          “Attr:reluSHVAcc”,
          “Attr:shvNegSlope”,
          “Attr:shvPosSlope”,
          “Attr:desc_count”,
          “Attr:descriptors”,
        ]
      }
    },
  “dtype”:
  {
    “global”: “Float16”
  },
  “resources”:
  {
    “memory”:
    {
      {
        “name”: “DDR_Heap”,
        “alignment”: 64,
        “dataTypeSize”: 2,
        “size”: 1024000000
      },
      {
        “name”: “CMX_NN”,
        “alignment”: 64,
        “dataTypeSize”: 2,
        “size”: 1024000000
      },
      {
        “name”: “CMX_UPA”,
        “alignment”: 64,
        “dataTypeSize”: 2,
        “size”: 1024000000
      },
      {
        “name”: “DDR_BSS”,
        “alignment”: 64,
        “dataTypeSize”: 2,
        “size”: 1024000000
      },
      {
        “name”: “ProgrammableInput”,
        “alignment”: 64,
        “dataTypeSize”: 2,
        “size”: 1024000000
      },
      {
        “name”: “ProgrammableOutput”,
        “alignment”: 64,
        “size”: 1024000000
      }
    },
    “barriers”:
    {
      “goups”: 8,
      “barriersPerGroup”: 8,
      “allocationMode”: STATIC,
      “reUseStragtegy”: minimalBIGColoring,
    }
  }
}
```

In the above example, a target descriptor file may include a variety of information describing resources of an example target machine learning device. For instance, as shown in the example above, a target descriptor may identify a number of operations (e.g., corresponding to operations defined in the compiler's operation registry) and name the individual computation resources capable of performing the operation. For instance, in the example above, a Convolution operation is named in the target descriptor and two compute resources, “SHAVE PROCESSOR” and “HARDWARE ACCELERATOR” are named as computation resources capable of performing convolutions. Further, under each compute resource, attributes of the compute resource are specified, such as variables used by the resource to perform the operation, the number of instances of the compute resources on the target, the data types supported by the compute resources, among other example information.

Continuing with the above illustration of an example target descriptor, resources of the corresponding target machine learning device may be identified and attributes of each resource defined. For instance, memory resources are named in the above example, together with the specific attributes of each memory resource. For instance, for a name, alignment, data type size, and memory size attribute are specified for each memory resource, among other example information (e.g., the type of the memory technology). Additionally, the above example names hardware barrier devices (“barriers”) implemented on the target device. In this example, a number of hardware barrier devices are identified, organized into eight groups, with eight hardware barrier devices provided in each group (for 64 total hardware barrier devices). Groups may be defined so that independent subsets of hardware barriers on the target device may be designated for independent use by respective processes during multiprocessing sessions (where multiple simultaneous processes (e.g., multiple simultaneous inferences) are running on the target device)). The target descriptor may also identify, which barrier allocation mode the compiler is to employ during compilation (e.g., static or dynamic), as well as which allocation algorithm or strategy to employ (e.g., during static allocation modes), such as a minimal Barrier-Interference-Graph (BIG) coloring algorithm (as shown in the above example). In other implementations, barrier allocation mode and/or allocation algorithm information may be alternatively specified in a compilation descriptor file (e.g., instead of the target descriptor). Further information may also be provided within example target descriptors, including similar resource-specific attributes for computation resources and communication resources, the data precision of the target, data type(s) supported by the target, among other examples.

In some implementations, during compilation of a trained neural network into a serialized binary for inference, the compiler is to allocate specific physical memory addresses to data structures (tensors) in the memory regions specified in the target descriptor file. These memory regions may be dependent on the resources of the target device. The specific region of memory that a specific data structure is assigned to reside in is typically determined during compilation passes that determine the order of execution of operations and/or map the execution of each operation to a particular compute resource. In order to allocate specific physical memory addresses, memory allocator objects may be created by the compiler. Memory allocators may be implemented as high level software-based memory management objects in the compiler. A memory allocator object may be instantiated by the compiler for each memory type that is specified in the target descriptor. The memory allocator object may include methods callable to manage the allocation of buffers of data in the memory region that the respective memory allocator manages according to an algorithm that is specified in the compilation descriptor file. For example, in the example target descriptor above, six example memory regions are identified in the example target system (e.g., DDR_HEAP, CMX_NN, CMX_UPA, DDR_BSS, ProgrammableInput, ProgrammableOutput, etc.). Accordingly, in such an example, six corresponding memory allocator objects may be instantiated by the compiler based on receiving the target descriptor, each memory allocator responsible for allocating buffers of data in the corresponding one of the memory regions. In some cases, a hardware accelerator may require that the data that it reads be aligned to a certain boundary in memory, among other architectural considerations. Accordingly, a memory allocator manages specific memory buffers properties during allocation, which may be based on such architectural requirements. Table 2 illustrates example properties, which may be stored for memory resources in example target descriptors, which may be used by an IR data model of the compiler and in memory allocation compilation passes, among other example uses:

TABLE 2
Example Memory Resource Attributes in Target descriptors

| Properties | Description |
|---|---|
| Unique ID | A unique ID of the buffer |
| Offset | A value specifying the start location of the buffer relative |
| | to the beginning of the whole memory block managed by |
| | the allocator |
| Size | The size of the buffer, added to the offset represents the end |
| | location of the buffer managed by the allocator |
| Stride | An array of values specifying the ‘memory stride’ between |
| | consequent storage memory block owned by the buffer |
| Block size | A value specifying the size of storage memory blocks owned |
| | by the buffer |
| Block | A value specifying the number of storage memory blocks |
| number | owed by the buffer |
| Post | The length of trailing, a block of empty memory that is |
| alignment | sued for alignment |
| Left | Left side padding of the tensor stored in the buffer |
| padding | |
| Right | Right side padding of the tensor stored in the buffer |
| padding | |

As introduced above, in some implementations, an example compiler may be further configured to generate an intermediate representation (including one or more graph-based sub-models) and represent operational synchronization dependencies in the intermediate representation. In some implementations, these synchronization dependencies may be implemented through barrier task objects. In some implementations, a barrier task object may facilitate optimal dynamic scheduling onto the particular hardware compute resources of a target machine learning device, while preserving the dependencies required by the original computation network (e.g., defined in the original neural network graph model). The barrier tasks may be executed to capture information, which would be utilized by runtime software to utilize the hardware barrier devices of the target device for task synchronization. The compiler may utilize the information captured through the barrier task objects to generate a corresponding binary executable to enable appropriate scheduling of tasks to implement the neural network on the particular target device. For instance, information captured through the barrier task objects may enable corresponding data to be generated (e.g., in the binary) to provide runtime software with synchronization data for consumption by runtime software and enable effective use of hardware barrier resources of a target machine learning device. Accordingly, an improved compiler may abstract the runtime software requirements regarding the allocation of hardware barriers to support dynamic and static hardware barrier allocation modes. Likewise, an example compiler may abstract the number of hardware barriers available to a process and the number of simultaneous processes permitted to run on the same machine learning device, among other example features. Such features may enable such improved compiler implementations to achieve better inference performance than traditional compilers used to facilitate deep learning applications.

In accordance with the above, during compilation of a trained neural network into a serialized binary for inference on a particular machine learning device, an improved compiler may be used to determine the availability of hardware barriers on the particular device and define use of the hardware barriers to incorporate synchronization of the serial/parallel operation of the tasks in the compute graph upon which the compiler builds the binary. For instance, information in either or both the operator and control models of the intermediate representation of the neural network graph may be consulted by the compiler to determine opportunities to use hardware barriers within the data and/or control flows of the neural network. Defining the hardware barrier usage may facilitate both optimal resource scheduling and correctly implementing corresponding neural network inferences.

In some implementations, a control model of an intermediate representation generated by the compiler for a particular neural network graph, may be used to host barrier task control operations. The compiler may insert barrier task data objects into this model (and potentially other sub-models) of the intermediate representation of the neural network graph. For instance, the barrier task objects may be inserted into control flows of the intermediate representation modeled by the control model. For instance, the compiler may parse the control flows represented in the intermediate representation and identify opportunities for the use of hardware barrier resources of the target device (e.g., by identifying dependencies between operations/tasks in the control flow). Insertion into the compute graph allows optimization and scheduling algorithms to manipulate the attributes collected in the barrier task object and its relation/dependencies to other tasks. In some implementations, the barrier task object may implement methods, which may be called to collect particular information for barrier usage at particular points within the control flow. The compiler may utilize this information to determine optimizations for hardware barriers in the neural network's implementations. For instance, with the barrier tasks inserted into the compute graph, the compiler may manipulate the barrier tasks, for instance, to merge or eliminate some barrier tasks, perform liveness analysis, and perform resource allocation (e.g., to allocate physical or virtual barrier resources to each of the barrier task objects representing opportunities for using the hardware barriers in the control flow).

In some implementations, a compiler support both static and dynamic hardware barrier allocation (e.g., based on the target device and/or as designated to the compiler (e.g., through a compilation descriptor file)). For instance, the compiler may implement a static barrier allocation mode in which the compiler assigns specific hardware barrier resources (e.g., as identified in a target descriptor for a given target computing device) to be used as the barriers identified for the control flow of the neural network. For instance, the compiler, in allocating the hardware barrier resources, may use an interference graph coloring technique to assign hardware index numbers to virtual barriers using either the minimum number of barriers required (e.g., minimal BIG coloring), or the maximum number of available hardware barriers (maximal BIG coloring), or some other barrier allocation technique or algorithm. In other instances, the compiler may implement a dynamic barrier allocation mode in which the compiler assigns a unique virtual barrier identifier to each barrier, assuming that a runtime agent (e.g., implemented in runtime software of the target device) will handle the actual hardware barrier allocation (dynamically) at the target device (e.g., based on the detected availability of hardware barrier devices during runtime). Under both modes (static and dynamic) of barrier allocation, the barrier task data object (represented in the intermediate representation of the graph generated by the compiler) will hold information resulting from analysis of a barrier live-ness (e.g., interference graph coloring). This information can be used to assist debug/visualization and hardware resource scheduling by the runtime software of the target device, among other example uses.

Table 3 illustrates example properties, which may be collected and stored for hardware barriers in corresponding barrier tasks objects, which may be used by the compiler in barrier allocation compilation passes, among other example uses:

TABLE 3
Example Properties in Barrier Task Objects

| Properties | Description |
|---|---|
| ID | A unique ID of a barrier (or virtual barrier index) |
| index | Under static barrier allocation mode: specific HW |
| | barrier allocated to this barrier task. (Hardware |
| | barriers may be re-used, so this is not necessarily |
| | a unique identifier) |
| | Under dynamic barrier allocation mode: same as ID |
| group | Hardware barrier group, a hierarchical structure of |
| | hardware resources allowing parallel processing |
| | of multiple inferences. Each process is only aware |
| | of its own barriers |
| numProducers | The number of preceding operations required to |
| | update this barrier. Upon completion, a producer |
| | will cause the hardware barrier counter to |
| | decrement/increment. |
| numConsumers | The number of operations waiting for this barrier |
| | to be set (counter reaches zero/count). |
| producers | A list of the operations that will cause the |
| | hardware barrier counter to decrement when |
| | they complete |
| consumers | A list of the operations that will wait for this barrier |
| | to be set |
| requiredConcurrentBarriers | A list of the barriers that must be concurrent |
| | (alive) with this barrier for correct sequential flow |
| | through the compute graph |
| possibleConccurrentBarriers | A list of the barriers that may be concurrent with |
| | this barrier, enabling parallelism under dynamic |
| | scheduling of operations |
| color | Color assignment resulting from Barrier- |
| | Interference-Graph (BIG) coloring |
| maxConcurrentBarriers | Maximum number of barriers which may be alive |
| | while this barrier is alive. (Number of different |
| | colors adjacent to this node in the BIG) |

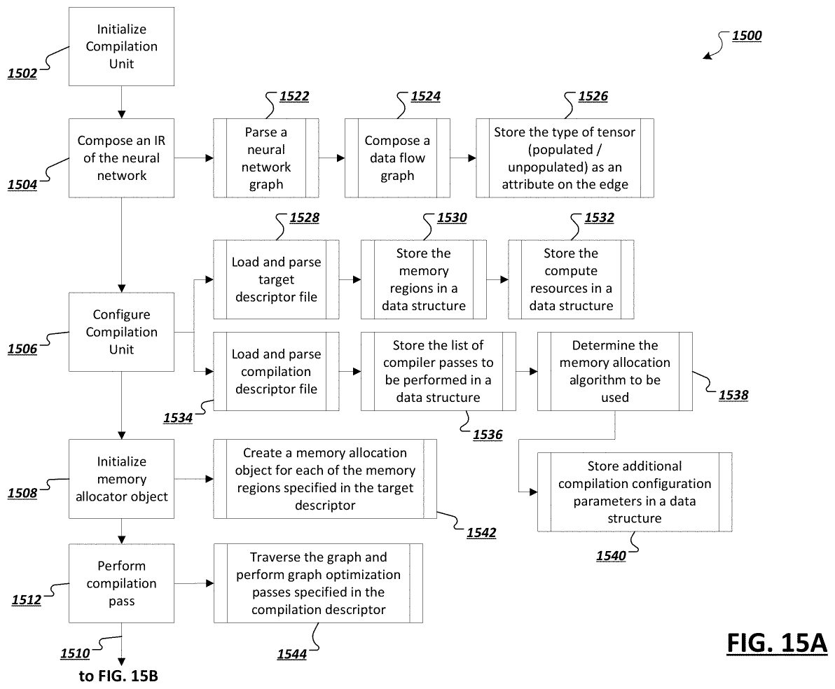

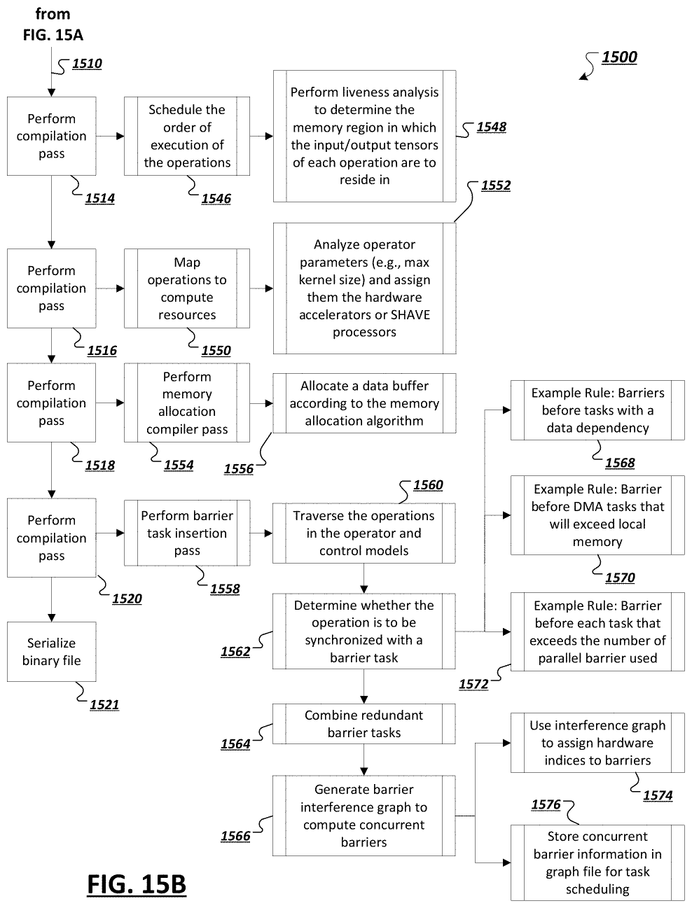

Turning to FIGS. 15A-15B, a flowchart 1500 is shown illustrating an example compilation using an improved compiler, such as discussed above. (Note that a top portion of the flowchart 1500 is illustrated in FIG. 15A, which continues into the bottom portion of the flowchart 1500 illustrated in FIG. 15B.) In one example implementation of an improved compiler, a compilation unit of the compiler may be initiated 1502, the compilation unit configured to manage the compilation of the deep neural network into a binary file for execution on a particular target device. An intermediate representation of the deep neural network may be composed 1504 by the compiler and a compilation unit may be configured 1506, for instance, using information in a target descriptor and compilation descriptor input to the compiler. A set of memory allocator objects may be instantiated and initialized 1508 based on information obtained for the particular target device (e.g., from a corresponding target descriptor file). The compilation flow continues (represented by arrow 1510), with the compiler performing a set of compilation passes (at 1512, 1514, 1516, 1518, 1520, etc.). Upon completion of the compilation passes, a transformed version of the neural network graph (transformed through the compilation passes 1512, 1514, 1516, 1518, etc.) may be used to generate 1521 binary file, which may be executed by the target device to implement the deep neural network.

Continuing with the example illustrated by flowchart 1500, composing an intermediate representation of the DNN may include (at 1522) parsing a neural network binary file (e.g., implemented as a graph data structure) at the compiler and composing an internal representation of the network with a direct translation of one operator to one or more nodes to generate sub-models of the intermediate representation. In some implementations, the sub-models may include an operator sub-model, a data sub-model, and a control sub-model, such as discussed herein. The operator sub-model may serve as a data flow graph and may be generated 1524 from the parsing. Further, tensors corresponding to the operations modeled in the operator graph may be determined 1526, as well as their type (e.g., populated (e.g., with a constant or other established input to the neural network) or unpopulated (e.g., with values to be determined as an output of a calculation of an operation)), and the tensors may be stored as an attribute of edges of the graph.

In some implementations, configuring 1506 the compilation unit of an example compiler may include loading and parsing a target descriptor file (at 1528) and loading and parsing a compilation descriptor file (at 1534). For the target descriptor file, memory regions identified in the target descriptor file may be stored 1530 in a data structure for future use by the compiler and, similarly, compute resources identified in the target descriptor may also be stored 1532 in a corresponding data structure for later use in the compilation. The list of compiler passes named in the compilation descriptor may also be stored 1536 in a data structure. The compilation descriptor may also identify to the compiler (at 1538) a memory allocation algorithm to be used during the compilation, as well as other additional compilation configuration parameters (e.g., the graph view to be generated as an output by the compiler (e.g., including an operator model, data model, and/or control model)), which may be stored 1540 in a data structure of the compiler to be applied during the compilation process.

Memory allocation objects created (at 1542) by the compiler to correspond to each of the identified memory regions of an example target device may be used, together with other models developed by the compiler (e.g., sub-models of the intermediate representation), to perform various compilation passes named in the compilation descriptor. In one example, compilation passes may be performed (at 1510), which include traversing 1544 the neural network graph input and performing hardware-agnostic graph optimization passes (e.g., as specified in the compilation descriptor), such as operation fusing or operation replacement, among other examples. The resulting version of the graph may be subject to further compilation passes (e.g., 1514), such as passes to schedule 1546 the order of execution of the operations and performing liveliness analyses 1548 to determine the memory region in which determined input/output tensors of each operation are reside in. Additional compilation passes (e.g., 1516) may be performed to map 1550 operations to the identified compute resources of the target hardware, for instance, by analyzing 1552 operator parameters (e.g. max kernel size) and assigning the operations to respective compute resources based on such operation parameters.

After initializing memory allocators and performing compilation passes to optimize the underlying neural network graph, determine an order of the operations, and mapping operations to respective compute resources, one or more additional compilation passes may be performed (at 1518) constituting memory allocation passes (at 1554). For instance, memory allocation passes 1554 may be performed to allocate 1556, for each tensor, data buffers (e.g., using corresponding memory allocator objects) to specific memory regions according to a specified memory allocation algorithm and based on properties determined for the tensor.

Additionally, after previous compilation passes (e.g., 1512,1514, 1516, etc.) have been performed to optimize the underlying neural network compute graph (and potentially after buffers have been allocated through one or more memory allocation passes (such as shown in the example of FIG. 15B)), additional compilation passes (e.g., 1520) may be performed to allocate hardware barrier resources for the optimized compute graph (at 1558). For instance, nodes in the transformed intermediate representation (e.g., in the operator and/or control graph sub-models) may be traversed 1560 and opportunities may be identified for using hardware barrier resources (e.g., counters) on the target computing device. For instance, the compiler may determine 1562 whether a given operation represented in the transformed graph models is to be synchronized with a barrier (and represented by a corresponding barrier task object). For instance, one or more rules, conditions, or algorithms may be defined (e.g., by the target descriptor or compilation descriptor, or from other data or in logic of the compiler) to determine whether a barrier should be inserted into the graph. For instance, barriers may be inserted (at 1568) before each direct memory access (DMA) and processor (e.g., DPU or SHAVE) operation/task that has a data dependency (on another operation/task), such as when a task (e.g., a mathematical or data movement operation) requires an output of a preceding operation/task before being able to successfully proceed. As another example, a barrier may be inserted (at 1570) before every DMA task that exceeds available local (e.g., CMX) memory. As yet another example, barriers may be inserted (at 1572) before every task/operation that exceeds the number of parallel barriers designated for use during the corresponding processing and implementation of the corresponding neural network (e.g., a group of eight hardware barriers (e.g., a subset of the overall barriers provided on the hardware) may be designated for a particular compute resource (e.g., for each DPU or SHAVE) or the aggregate collection of compute resources on the target device, etc.), among other example conditions or rules. For instance, barriers may also be inserted before operations that have a control dependency graph edge which forces serial operation, without data dependency. This control edge may have been added by the compiler to enable fitting into hardware resources (e.g., during one of the preceding optimization passes), or by a manually generated schedule, among other examples.

With the barriers inserted into the graph (e.g., within the control model graph), graph theory-based analyses may be performed, among other optimization techniques, by the compiler, to identify opportunities to reduce the number of or otherwise optimize the barrier tasks. For instance, redundant barrier tasks may be combined 1564 (e.g., when two or more operation rely on the same preceding dependencies, they may share the same barrier (rather than each requiring their own distinct barrier)), among other optimization steps. In other instances, changes may be made to the underlying control flow or data flow represented in the intermediate representation based on limited hardware barrier resources (e.g., to serialize operations when the number of parallel control flow paths outnumber the number of hardware barrier devices available on the target computing device, among other examples). Further, liveness analysis may be performed by the compiler by generating 1566 a barrier interference graph to compute concurrent barrier and possible concurrent barriers for the neural network's control path (and based on the representation of the graph with the inserted barrier task objects). For instance, a control model graph may represent and be used to analyze barrier concurrency. For instance, each vertex of the model graph may represent a barrier in this barrier interference graph (BIG). Edges may be placed between vertices that must be concurrent due to shared operations and also between vertices that may be concurrent allowing parallel processing under dynamic runtime scheduling. The interference graph may be used 1574 to assign hardware indices to the barriers, either statically or dynamically. The results of this live-ness analysis may identify concurrent barrier information and may be stored 1576 in the barrier task objects or elsewhere in the transformed graph representation(s) of the intermediate representation, to be used by the compiler in generating binary code to facilitate task scheduling using the hardware barrier resources (e.g., by runtime software), among other example compilation passes. For instance, by determining which hardware barrier indices are or can be concurrent with a particular hardware barrier (assigned a particular index), it can be determined which other hardware barriers may not be used concurrently with the particular hardware barrier, among other uses by the runtime software of the target. In some implementations, the binary code may include copies of the barrier task objects themselves, for consumption by the runtime software to determine how to manage synchronization and control flow of the neural network's implementation. When all compilation passes are completed, a serialization pass may be performed (e.g., at 1521) to create a binary file that specifies the sequences of operations to be performed and the memory locations of each of the tensors, all tuned to the specific hardware of the target hardware.

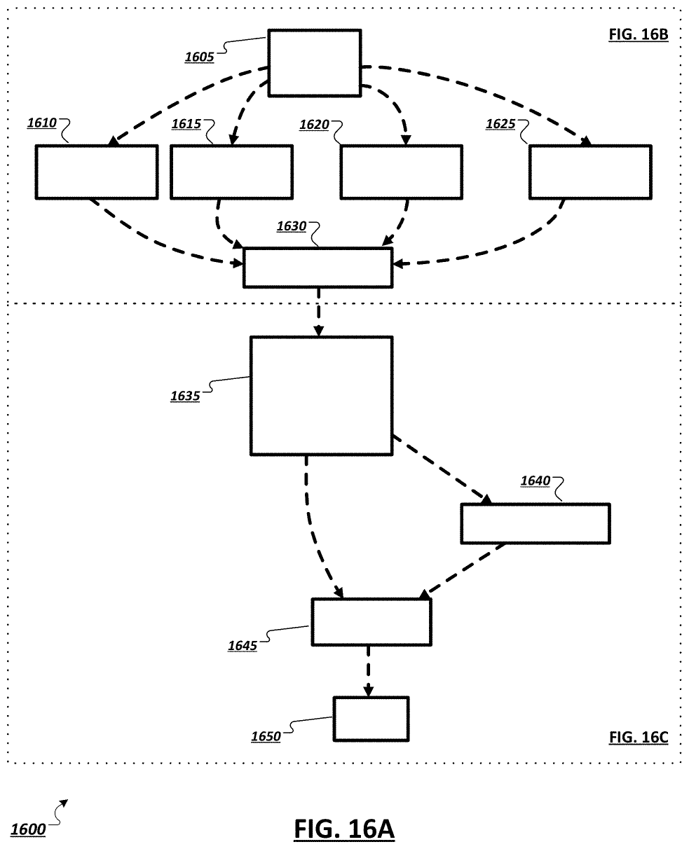

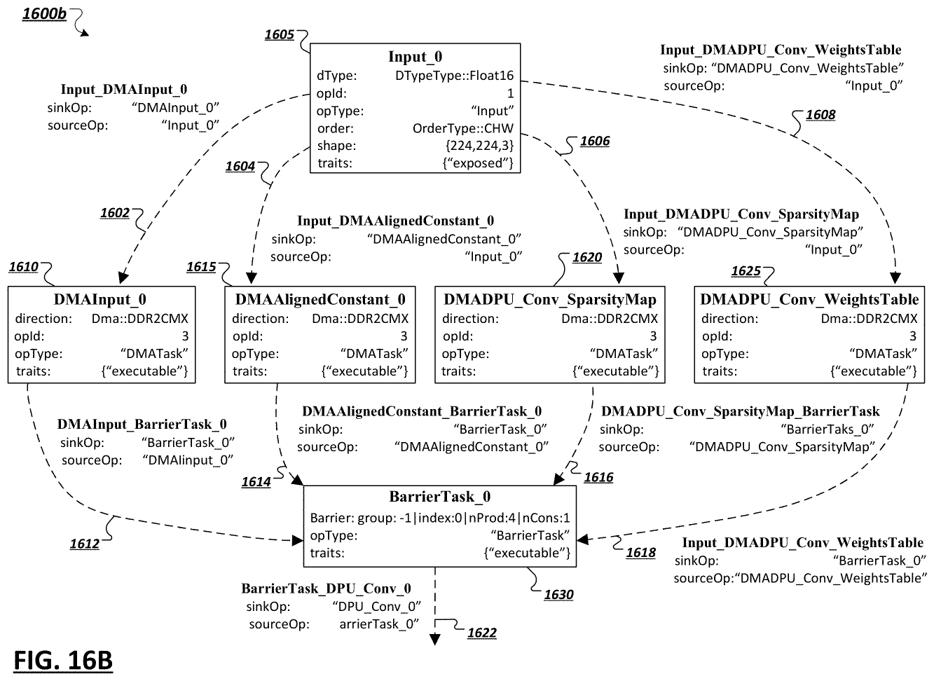

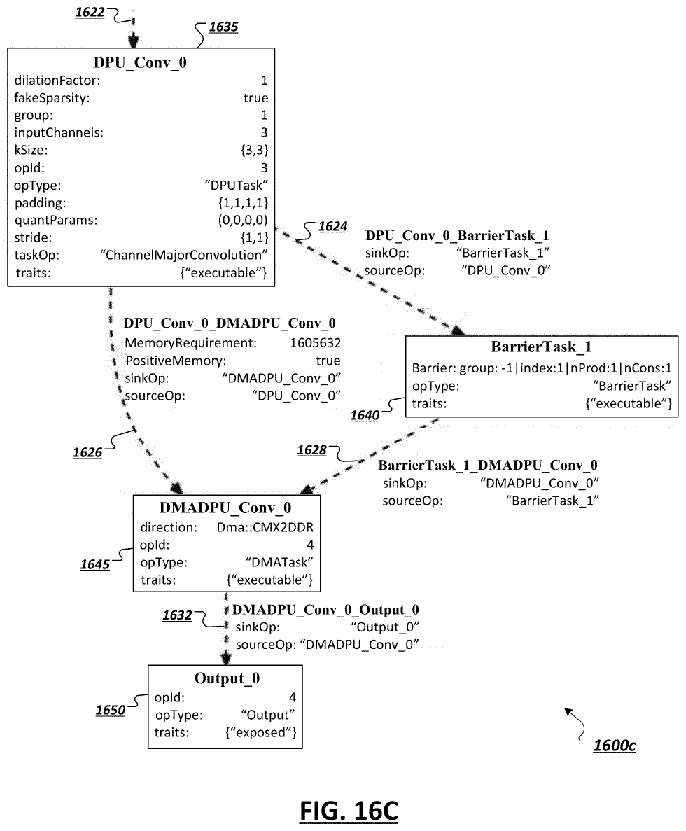

FIGS. 16A-16C illustrate an example of a graph model 1600 of an intermediate representation of a neural network compute graph, as generated and transformed by a compiler, to include the insertion of example barrier tasks within the graph. FIG. 16A illustrates a high-level view of an example control flow graph model 1600 and illustrates how the portions 1600b, 1600c of the graph illustrated in FIGS. 16B-16C connect. For instance, beginning with the portion 1600b illustrated in FIG. 16B, an input operation 1605 may be provided to obtain data for use (e.g., as operands) of a subsequent convolution operation 1635 (e.g., performed by a DPU). In one example, the original compute graph of the example neural network may include the input operation 1605, convolution operation 1635, and output operation 1650. A compiler may generate an operator model and an operator model within an intermediate representation of the neural network (such as discussed in the examples above). A set of compilation passes may be performed, based at least in part on a target descriptor identifying the particular resources of a target computing device that is to implement the neural network. Each compilation pass may transform the intermediate representation of the neural network at some level (e.g., changing certain sub-model graphs of the intermediate representation) to realize optimizations or modifications determined through the compilation pass. The representation of an example intermediate representation graph model 1600 may reflect a version of the graph transformed after completion of a collection of compilation passes. For instance, direct memory access (DMA) operations (e.g., 1610, 1615, 1620, 1625, 1645) may be identified (e.g., which may be added through one or more compilation passes based on the specific memory, DMA, and other resources of the target computing device, or which may be explicitly defined in the original graph) to implement the neural network on a target, among other examples. As in the examples above, operations (e.g., 1605, 1610, 1615, 1620, 1625, 1645, 1650) may be represented as nodes in the graph model 1600. Attributes of each of these operations may also be determined (by the compiler) and populated in the graph model 1600.

Continuing with the example of FIGS. 16A-16C, a compiler may determine (e.g., from a target descriptor) that a particular target computing system has a set of hardware barrier resources and, based on this determination, may perform one or more compilation passes to insert barrier tasks in the control flow graph of the intermediate representation and generate corresponding barrier task objects. For instance, in the example graph representation 1600, a compiler may insert two barrier tasks 1630, 1640 as new nodes in the graph 1600. Corresponding edges (e.g., 1612, 1614, 1616, 1618, 1624) may be defined to identify inputs to the barrier tasks 1630, 1640 (e.g., to indicate completion of producer tasks) and to identify outputs of the barrier tasks 1630, 1645 (e.g., edges 1622, 1628) to indicate, to a consumer task, that the consumer task may begin, among other examples. Compilation passes may also be performed to optimize or consolidate the identified barrier tasks. For instance, barrier task 1630 may reflect a consolidation of four initially determined barrier tasks by the compiler corresponding to each of producer operations 1610, 1615, 1620, 1625, among other examples. Barrier task objects (corresponding to each of barrier tasks 1630, 1645) may be generated by the compiler and may be used (in one or more compilation passes) to identify and document attributes of each of the barriers to be used by the target hardware, including whether static or dynamic allocation is to be implement, the indices (or other identifiers) assigned to each of the barriers represented in the graph, a group to which the barrier is assigned, concurrent barriers associated with the barrier, among other example information. The transformed compute graph determined from these (and other) compilation passes may then be utilized by the compiler as the basis for generating a binary executable, which enables to the target computing device to implement the corresponding neural network, while making effective use of the synchronization enabled by allocation of the target device's hardware barrier resources during the implementation of the neural network.

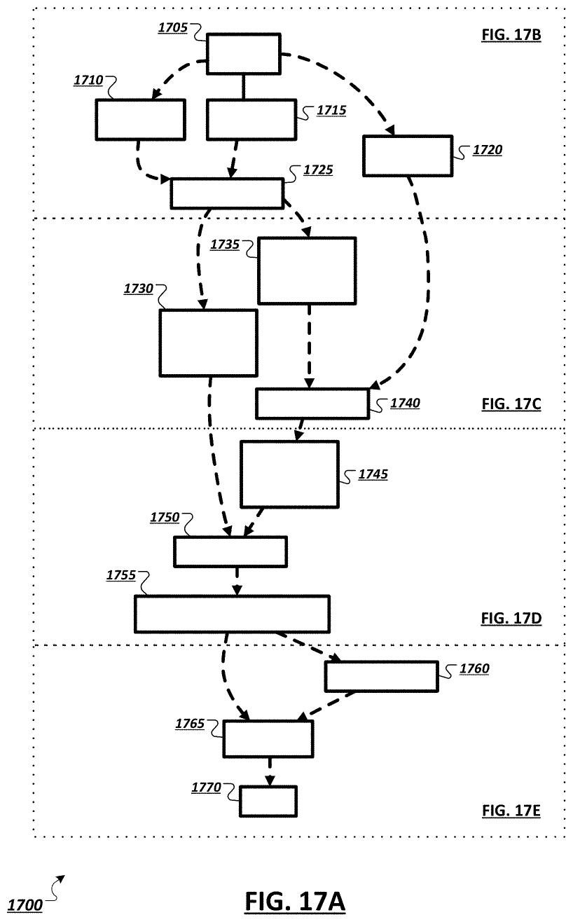

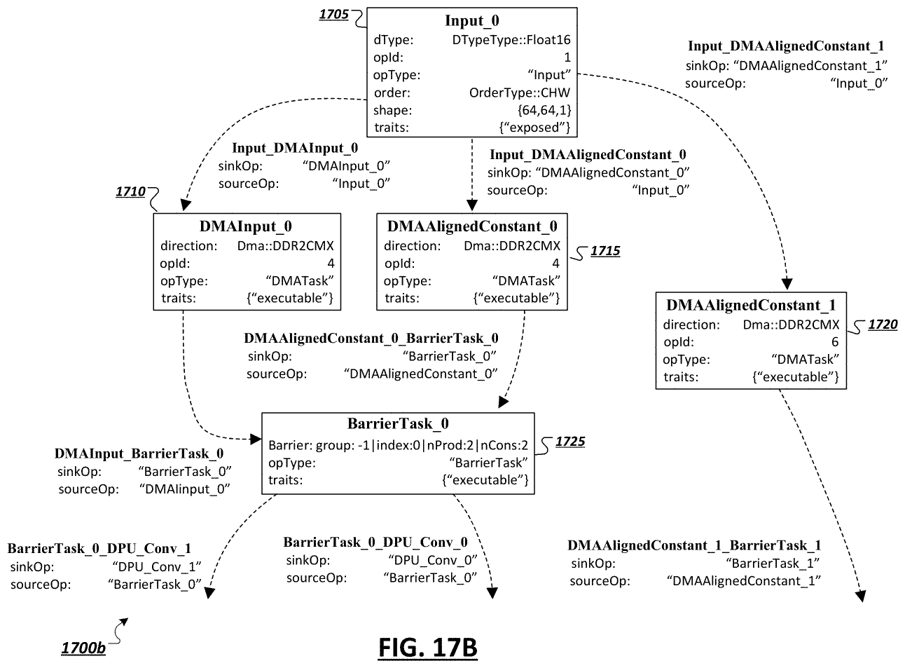

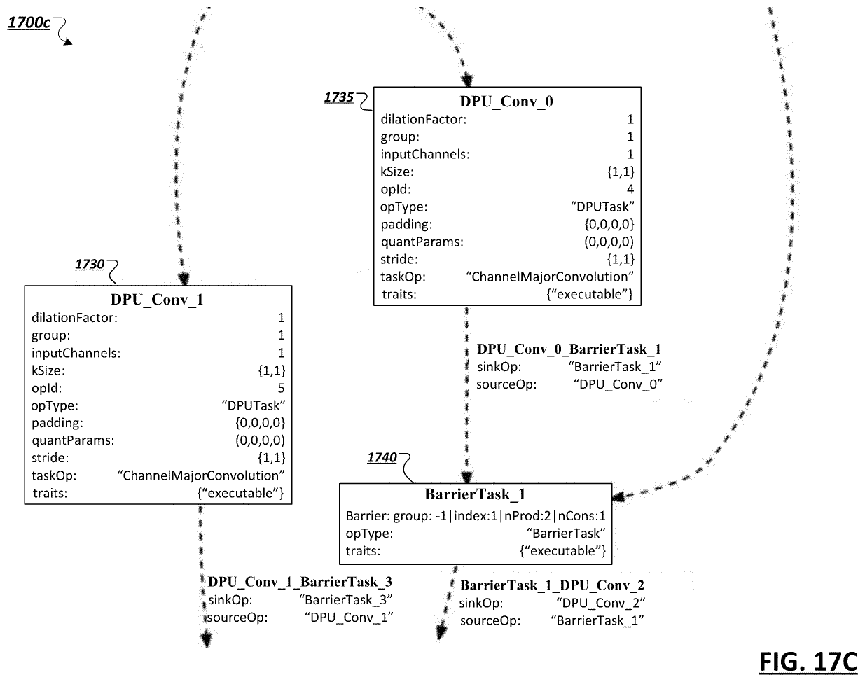

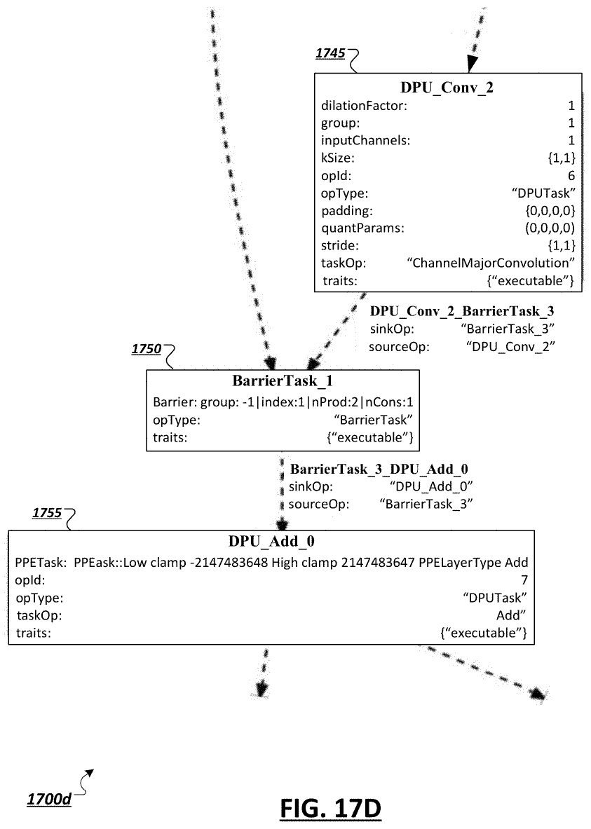

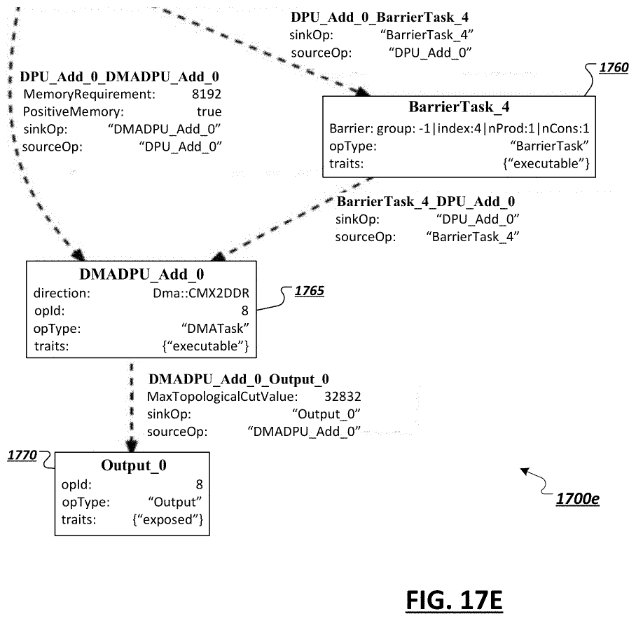

FIGS. 17A-17E illustrate another, more complex example of a graph model 1700 of an intermediate representation of a neural network compute graph including barrier tasks inserted by an example compiler. FIG. 17A illustrates a high-level view of the graph model 1700 and illustrates how the graph portions 1700b-e illustrated in FIGS. 17B-17E connect. As in the example of FIGS. 16A-C, a data and/or control flow graph model (e.g., 1700) may be generated in an intermediate representation by the compiler and used in a variety of compilation passes, including compilation passes to identify opportunities to use hardware barrier resources of a given target computing device. The example graph 1700 may reflect the graph as transformed by a collection of compilation passes, including passes used to insert and optimize barrier tasks in the data flow of the graph. In the particular example of FIGS. 17A-17E, four barrier tasks (e.g., 1725, 1740, 1750, 1760) may be identified and defined within the intermediate representation based on dependencies or other rules affecting the operations (e.g., 1705, 1710, 1715, 1720, 1730, 1735, 1745, 1755, 1765, 1770) determined by the compiler for implementing a particular neural network. For instance, based on a data dependency (e.g., of DPU convolution operation 1745, of DPU addition operation 1755, etc.), a DMA task (e.g., corresponding to DMA operations (e.g., 1710, 1715, 1720, 1765)), or based on other rules, conditions, or algorithms, corresponding barriers may be defined and inserted into the graph. Corresponding barrier task objects may also be instantiated. The barrier tasks objects may be populated with information, which may be provided to the target computing device (e.g., in the binary executable or through copies of the barrier tasks objects themselves, among other example implementations), for use by runtime software of the target device in allocating and using the target device's hardware barrier resources to enable effective synchronization of tasks during implementation of the neural network (e.g., and the performance of corresponding inferences). It should be appreciated that the example graphs of FIGS. 16A-17E are presented as illustrative examples only and that a potentially limitless variety of alternative example exist, which may be determined by improved compilers, including various graphs and barrier tasks determined based on the underlying neural network model, the hardware barriers available on particular target machine learning devices, the barrier allocation algorithms designated to be used during the compilation, among other example variables.

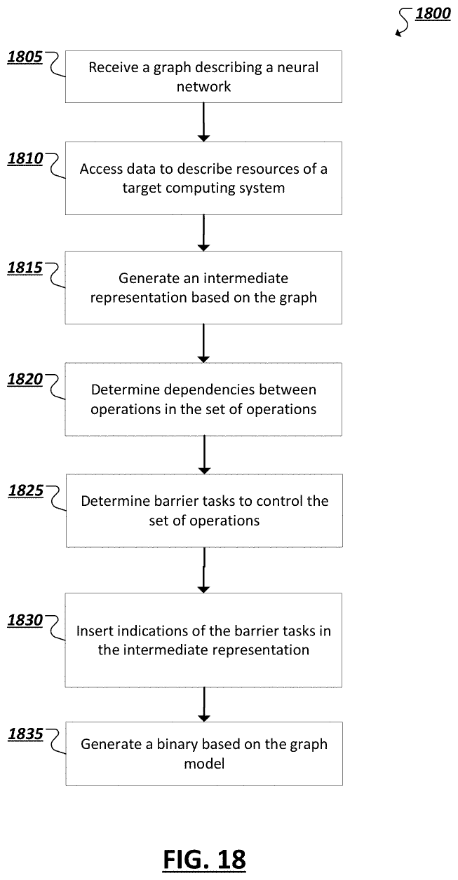

FIG. 18 is a simplified flowchart 1800 showing an example technique for generating binary executable to implement neural networks on target computing devices using improved compilers, such as discussed above. For instance, a graph may be received 1805 as an input to a compiler, the graph describing/modeling a particular neural network. Data may be accessed 1810 by the compiler, which describes attributes of a target computing device on which the neural network is to be implemented. In some implementations, this information may be contained in a target descriptor file provided as an input to the compiler to describe the attributes of the particular target computing device. An intermediate representation of the graph may be generated 1615 by the compiler based on the graph and the data, with the intermediate representation composed of sub-models, such as an operator model, data model, and control model. The intermediate representation, among other information, may identify a set of operations to be performed to implement the neural network on the target computing device. A collection of compilation passes may be performed using the intermediate representation. In some implementations, compilation passes may be performed using the intermediate representation (and after certain transformations and optimizations have been made to the intermediate representation from preceding compilation passes) to determine 1820 dependencies between the set of operations. Based on these dependencies (e.g., control and data dependencies, and potentially other configurable rules), opportunities to utilize hardware barrier resources on the target device may be identified. Barrier tasks may be determined 1825 based on these opportunities, where barrier tasks are operations to be performed using the hardware barrier resources to control and synchronize performance of the set of operations used to implement the neural network. Indications of these hardware barrier tasks may be inserted 1830 into the intermediate representation (e.g., as new nodes within a control or data flow graph in one or more sub-models of the intermediate representation). In some implementations, barrier task objects may be generated to correspond to each of the identified barrier tasks (and may themselves serve as the indications of the hardware barrier tasks within the intermediate representation). The intermediate representation (and its graph model(s) used to indicate the hardware barrier tasks) may be used by the compiler to generate 1830 a binary executable tuned for execution by the target computing device. The binary may include code to direct the target computing device to allocate and use particular hardware barrier resources (e.g., according to a static or dynamic allocation mode) to perform the barrier tasks during its implementation of (e.g., performing inferences based on) the neural network.

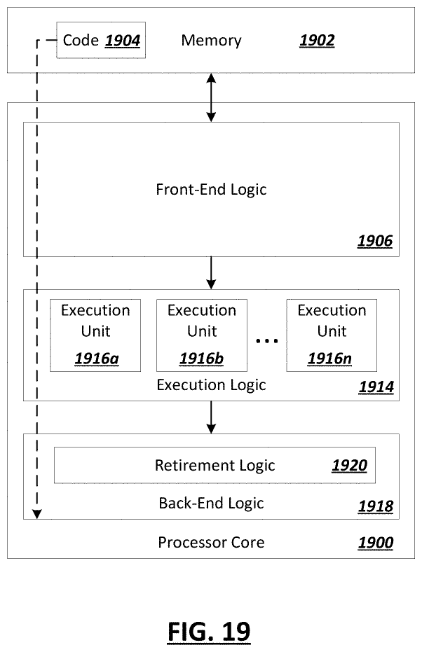

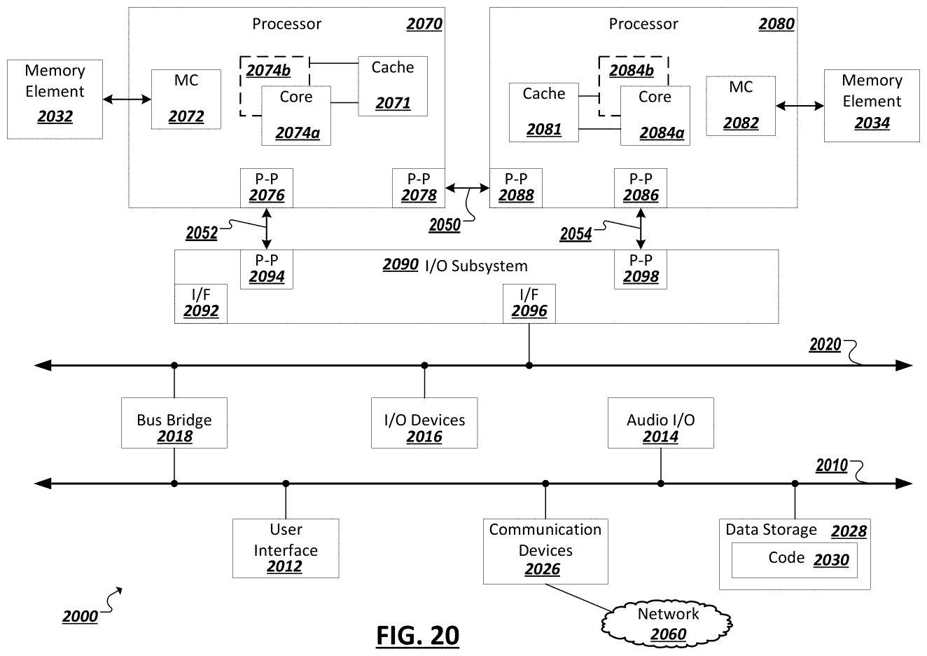

FIGS. 19-20 are block diagrams of exemplary computer architectures that may be used in accordance with embodiments disclosed herein. For instance, the computer architectures shown in these examples may be utilized to implement or execute an improved compiler and/or a portion of a target computing device. In other examples, the computer architectures shown in these examples may consume results generated by the neural network, provide data for use as inputs to the neural networks, among other cooperative uses. It should be appreciated that other computer architecture designs known in the art for processors and computing systems may also be used. Generally, suitable computer architectures for embodiments disclosed herein can include, but are not limited to, configurations illustrated in FIGS. 19-20.

FIG. 19 is an example illustration of a processor according to an embodiment. Processor 1900 is an example of a type of hardware device that can be used in connection with the implementations above. Processor 1900 may be any type of processor, such as a microprocessor, an embedded processor, a digital signal processor (DSP), a network processor, a multi-core processor, a single core processor, or other device to execute code. Although only one processor 1900 is illustrated in FIG. 19, a processing element may alternatively include more than one of processor 1900 illustrated in FIG. 19. Processor 1900 may be a single-threaded core or, for at least one embodiment, the processor 1900 may be multi-threaded in that it may include more than one hardware thread context (or “logical processor”) per core.

FIG. 19 also illustrates a memory 1902 coupled to processor 1900 in accordance with an embodiment. Memory 1902 may be any of a wide variety of memories (including various layers of memory hierarchy) as are known or otherwise available to those of skill in the art. Such memory elements can include, but are not limited to, random access memory (RAM), read only memory (ROM), logic blocks of a field programmable gate array (FPGA), erasable programmable read only memory (EPROM), and electrically erasable programmable ROM (EEPROM).

Processor 1900 can execute any type of instructions associated with algorithms, processes, or operations detailed herein. Generally, processor 1900 can transform an element or an article (e.g., data) from one state or thing to another state or thing.

Code 1904, which may be one or more instructions to be executed by processor 1900, may be stored in memory 1902, or may be stored in software, hardware, firmware, or any suitable combination thereof, or in any other internal or external component, device, element, or object where appropriate and based on particular needs. In one example, processor 1900 can follow a program sequence of instructions indicated by code 1904. Each instruction enters a front-end logic 1906 and is processed by one or more decoders 1908. The decoder may generate, as its output, a micro operation such as a fixed width micro operation in a predefined format, or may generate other instructions, microinstructions, or control signals that reflect the original code instruction. Front-end logic 1906 also includes register renaming logic 1910 and scheduling logic 1912, which generally allocate resources and queue the operation corresponding to the instruction for execution.

Processor 1900 can also include execution logic 1914 having a set of execution units 1916a, 1916b, 1916n, etc. Some embodiments may include a number of execution units dedicated to specific functions or sets of functions. Other embodiments may include only one execution unit or one execution unit that can perform a particular function. Execution logic 1914 performs the operations specified by code instructions.

After completion of execution of the operations specified by the code instructions, back-end logic 1918 can retire the instructions of code 1904. In one embodiment, processor 1900 allows out of order execution but requires in order retirement of instructions. Retirement logic 1920 may take a variety of known forms (e.g., re-order buffers or the like). In this manner, processor 1900 is transformed during execution of code 1904, at least in terms of the output generated by the decoder, hardware registers and tables utilized by register renaming logic 1910, and any registers (not shown) modified by execution logic 1914.

Although not shown in FIG. 19, a processing element may include other elements on a chip with processor 1900. For example, a processing element may include memory control logic along with processor 1900. The processing element may include I/O control logic and/or may include I/O control logic integrated with memory control logic. The processing element may also include one or more caches. In some embodiments, non-volatile memory (such as flash memory or fuses) may also be included on the chip with processor 1900.

FIG. 20 illustrates a computing system 2000 that is arranged in a point-to-point (PtP) configuration according to an embodiment. In particular, FIG. 20 shows a system where processors, memory, and input/output devices are interconnected by a number of point-to-point interfaces.

Processors 2070 and 2080 may also each include integrated memory controller logic (MC) 2072 and 2082 to communicate with memory elements 2032 and 2034. Example processors (e.g., 2070, 2080) may include one or more processor cores (e.g., 2074a-b, 2048a-b), which may be coupled to respective cache memory (e.g., 2071, 2082). In alternative embodiments, memory controller logic 2072 and 2082 may be discrete logic separate from processors 2070 and 2080. Memory elements 2032 and/or 2034 may store various data to be used by processors 2070 and 2080 in achieving operations and functionality outlined herein.

Processors 2070 and 2080 may be any type of processor, such as those discussed in connection with other figures. Processors 2070 and 2080 may exchange data via a point-to-point (PtP) interface 2050 using point-to-point interface circuits 2078 and 2088, respectively. Processors 2070 and 2080 may each exchange data with a chipset 2090 via individual point-to-point interfaces 2052 and 2054 using point-to-point interface circuits 2076, 2086, 2094, and 2098. Chipset 2090 may also exchange data with a co-processor 2038, such as a high-performance graphics circuit, machine learning accelerator, or other co-processor 2038, via an interface 2039, which could be a PtP interface circuit. In alternative embodiments, any or all of the PtP links illustrated in FIG. 20 could be implemented as a multi-drop bus rather than a PtP link.

Chipset 2090 may be in communication with a bus 2020 via an interface circuit 2096. Bus 2020 may have one or more devices that communicate over it, such as a bus bridge 2018 and I/O devices 2016. Via a bus 2010, bus bridge 2018 may be in communication with other devices such as a user interface 2012 (such as a keyboard, mouse, touchscreen, or other input devices), communication devices 2026 (such as modems, network interface devices, or other types of communication devices that may communicate through a computer network 2060), audio I/O devices 2014, and/or a data storage device 2028. Data storage device 2028 may store code 2030, which may be executed by processors 2070 and/or 2080. In alternative embodiments, any portions of the bus architectures could be implemented with one or more PtP links.

The computer system depicted in FIG. 20 is a schematic illustration of an embodiment of a computing system that may be utilized to implement various embodiments discussed herein. It will be appreciated that various components of the system depicted in FIG. 20 may be combined in a system-on-a-chip (SoC) architecture or in any other suitable configuration capable of achieving the functionality and features of examples and implementations provided herein.

While some of the systems and solutions described and illustrated herein have been described as containing or being associated with a plurality of elements, not all elements explicitly illustrated or described may be utilized in each alternative implementation of the present disclosure. Additionally, one or more of the elements described herein may be located external to a system, while in other instances, certain elements may be included within or as a portion of one or more of the other described elements, as well as other elements not described in the illustrated implementation. Further, certain elements may be combined with other components, as well as used for alternative or additional purposes in addition to those purposes described herein.

Further, it should be appreciated that the examples presented above are non-limiting examples provided merely for purposes of illustrating certain principles and features and not necessarily limiting or constraining the potential embodiments of the concepts described herein. For instance, a variety of different embodiments can be realized utilizing various combinations of the features and components described herein, including combinations realized through the various implementations of components described herein. Other implementations, features, and details should be appreciated from the contents of this Specification.

Although this disclosure has been described in terms of certain implementations and generally associated methods, alterations and permutations of these implementations and methods will be apparent to those skilled in the art. For example, the actions described herein can be performed in a different order than as described and still achieve the desirable results. As one example, the processes depicted in the accompanying figures do not necessarily require the particular order shown, or sequential order, to achieve the desired results. In certain implementations, multitasking and parallel processing may be advantageous. Additionally, other user interface layouts and functionality can be supported. Other variations are within the scope of the following claims.

While this specification contains many specific implementation details, these should not be construed as limitations on the scope of any inventions or of what may be claimed, but rather as descriptions of features specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

The following examples pertain to embodiments in accordance with this Specification. Example 1 is a machine-readable storage medium with instructions stored thereon, where the instructions are executable by a machine to cause the machine to: receive, at a compiler, a graph describing a neural network; access data to describe a target computing device to implement the neural network, where the target computing device includes a plurality of hardware barrier components; generate, at the compiler, an intermediate representation of the graph, where the intermediate representation identifies a set of operations to be performed to implement the neural network; determine dependencies between the set of operations; determine a set of barrier tasks to be performed to control flow of the set of operations based on the dependencies, where the set of barrier tasks are to be performed using the plurality of hardware barrier components; insert indications of the barrier tasks into the intermediate representation; and generate a binary executable based at least in part on the indications of the barrier tasks.

Example 2 includes the subject matter of example 1, where the indications are inserted as new nodes in a graph model of the intermediate representation to represent the set of barrier tasks in the flow of the set of operations.

Example 3 includes the subject matter of example 2, where the instructions are further executable to cause a machine to generate respective barrier task objects for each of the set of barrier tasks.

Example 4 includes the subject matter of example 3, where the barrier tasks objects are to identify attributes of the corresponding barrier task for use in allocating one of the hardware barrier components to implement the corresponding barrier task.

Example 5 includes the subject matter of any one of examples 2-4, where the intermediate representation includes an operator model, a control model, and a data model, and the graph model includes at least one of the operator model, the control model, and the data model.

Example 6 includes the subject matter of example 5, where the indications are inserted into the control model.

Example 7 includes the subject matter of any one of examples 5-6, where the dependencies are determined from at least one of the operator model or the control model.

Example 8 includes the subject matter of any one of examples 1-7, where the instructions are further executable to cause a machine to perform a set of compilation passes using the compiler, and at least a particular one of the set of compilation passes is to allocate a respective one of the plurality of hardware barrier components to implement each one of the barrier tasks.

Example 9 includes the subject matter of example 8, where at least another one of the set of compilation passes is to determine the set of barrier tasks based on the intermediate representation.

Example 10 includes the subject matter of example 8, where the particular compilation pass is to be performed after a subset of other compilation passes in the set of compilation passes.

Example 11 includes the subject matter of example 10, where the subset of other compilation passes includes one or more adaptation passes and one or more optimization passes.

Example 12 includes the subject matter of any one of examples 1-11, where the binary executable is executable to cause a static allocation of the plurality of hardware barrier components to implement the barrier tasks.

Example 13 includes the subject matter of example 12, where the binary executable is executable to cause the static allocation based on a particular graph coloring algorithm.

Example 14 includes the subject matter of any one of examples 1-13, where the binary executable is executable to cause a dynamic allocation of the plurality of hardware barrier components at the target computing device to implement the set of barrier tasks.

Example 15 includes the subject matter of any one of examples 1-14, where the data includes a target descriptor file to identify attributes of the plurality of hardware barriers components, and the set of barrier tasks is to be allocated to hardware barrier components in the plurality of hardware barrier components based at least in part on the attributes.

Example 16 includes the subject matter of any one of examples 1-15, where the set of barrier tasks are based on a set of rules.

Example 17 includes the subject matter of any one of examples 1-16, where one or more of the set of barrier tasks are inserted to control the start of a second one of the set of operations that is to use data generated from completion of a first one of the set of operations.

Example 18 includes the subject matter of example 17, where one or more of the set of barrier tasks are inserted based on timing of a direct memory access (DMA) operation in the set of operations.

Example 19 is a method including: receiving, at a compiler, a graph describing a neural network; accessing data to describe a target computing device to implement the neural network, where the target computing device includes a plurality of hardware barrier components; generating, at the compiler, an intermediate representation of the graph, where the intermediate representation identifies a set of operations to be performed to implement the neural network; determining dependencies between the set of operations; inserting, in the intermediate representation, indications of hardware barriers in the plurality of hardware barrier components to be used when performing the set of operations based on the dependencies; and generating a binary executable based at least in part on the indications of the hardware barriers.

Example 20 includes the subject matter of example 19, where the indications include indications of a set of barrier tasks to control timing of the set of operations.

Example 21 includes the subject matter of example 20, where the indications are inserted as new nodes in a graph model of the intermediate representation to represent the set of barrier tasks in the flow of the set of operations.

Example 22 includes the subject matter of example 21, where the instructions are further executable to cause a machine to generate respective barrier task objects for each of the set of barrier tasks.

Example 23 includes the subject matter of example 22, where the barrier tasks objects are to identify attributes of the corresponding barrier task for use in allocating one of the hardware barrier components to implement the corresponding barrier task.

Example 24 includes the subject matter of any one of examples 19-23, where the intermediate representation includes an operator model, a control model, and a data model, and the graph model includes at least one of the operator model, the control model, and the data model.

Example 25 includes the subject matter of example 24, where the indications are inserted into the control model.

Example 26 includes the subject matter of example 24, where the dependencies are determined from at least one of the operator model or the control model.

Example 27 includes the subject matter of any one of examples 20-26, further including performing a set of compilation passes using the compiler, and at least a particular one of the set of compilation passes is to allocate a respective one of the plurality of hardware barrier components to implement each one of the barrier tasks.

Example 28 includes the subject matter of example 27, where at least another one of the set of compilation passes is to determine the set of barrier tasks based on the intermediate representation.

Example 29 includes the subject matter of example 27, where the particular compilation pass is to be performed after a subset of other compilation passes in the set of compilation passes.

Example 30 includes the subject matter of example 29, where the subset of other compilation passes includes one or more adaptation passes and one or more optimization passes.

Example 31 includes the subject matter of any one of examples 20-30, where the binary executable is executable to cause a static allocation of the plurality of hardware barrier components to implement the barrier tasks.

Example 32 includes the subject matter of example 31, where the binary executable is executable to cause the static allocation based on a particular graph coloring algorithm.

Example 33 includes the subject matter of any one of examples 20-32, where the binary executable is executable to cause a dynamic allocation of the plurality of hardware barrier components at the target computing device to implement the set of barrier tasks.

Example 34 includes the subject matter of any one of examples 20-33, where the data includes a target descriptor file to identify attributes of the plurality of hardware barriers components, and the set of barrier tasks is to be allocated to hardware barrier components in the plurality of hardware barrier components based at least in part on the attributes.

Example 35 includes the subject matter of any one of examples 20-34, where the set of barrier tasks are based on a set of rules.

Example 36 includes the subject matter of any one of examples 20-35, where one or more of the set of barrier tasks are inserted to control the start of a second one of the set of operations that is to use data generated from completion of a first one of the set of operations.

Example 37 includes the subject matter of any one of examples 20-36, where one or more of the set of barrier tasks are inserted based on timing of a direct memory access operation in the set of operations.

Example 38 is a system including means to perform the method of any one of claims 19-37.

Example 39 includes the subject matter of example 38, where the means includes a neural network compiler.

Example 40 is a system including: a data processor; a memory; and a compiler. The compiler is executable by the data processor to: receive a graph describing a neural network; access data to describe a target computing device to implement the neural network, where the target computing device includes a plurality of hardware barrier components; generate an intermediate representation of the graph, where the intermediate representation identifies a set of operations to be performed to implement the neural network; determine dependencies between the set of operations from the intermediate representation; determine, based on the dependencies, a set of barrier tasks to be performed to control start of at least some of the set of operations; insert indications of the set of barrier tasks in the intermediate representation; determine allocation information for allocating hardware barrier components in the plurality of hardware barrier components to implement each of the set of barrier tasks; and generate a binary executable based at least in part on the allocation information.

Example 41 includes the subject matter of example 40, where the compiler is further executable to: generate a respective barrier task object for each of the set of barrier tasks; and populate each of the barrier task objects with information to facilitate allocation of hardware barrier components in the plurality of hardware barrier components to implement the set of barrier tasks.

Example 42 includes the subject matter of any one of examples 40-41, where the allocation information defines a static allocation of the hardware barrier components to the barrier tasks based on a particular Barrier-Interference-Graph (BIG) coloring algorithm.

Example 43 includes the subject matter of any one of examples 40-41, where the allocation includes a dynamic allocation, and the target computing device is to dynamically allocate the hardware barrier components to implement the set of barrier tasks at runtime based on the allocation information.

Example 44 includes the subject matter of any one of examples 40-43, where the indications are inserted as new nodes in a graph model of the intermediate representation to represent the set of barrier tasks in the flow of the set of operations.

Example 45 includes the subject matter of example 44, where the instructions are further executable to cause a machine to generate respective barrier task objects for each of the set of barrier tasks.

Example 46 includes the subject matter of example 45, where the barrier tasks objects are to identify attributes of the corresponding barrier task for use in allocating one of the hardware barrier components to implement the corresponding barrier task.

Example 47 includes the subject matter of any one of examples 44-46, where the intermediate representation includes an operator model, a control model, and a data model, and the graph model includes at least one of the operator model, the control model, and the data model.

Example 48 includes the subject matter of example 47, where the indications are inserted into the control model.

Example 49 includes the subject matter of any one of examples 47-48, where the dependencies are determined from at least one of the operator model or the control model.

Example 50 includes the subject matter of any one of any one of examples 40-49, where the instructions are further executable to cause a machine to perform a set of compilation passes using the compiler, and at least a particular one of the set of compilation passes is to allocate a respective one of the plurality of hardware barrier components to implement each one of the barrier tasks.

Example 51 includes the subject matter of example 50, where at least another one of the set of compilation passes is to determine the set of barrier tasks based on the intermediate representation.

Example 52 includes the subject matter of example 50, where the particular compilation pass is to be performed after a subset of other compilation passes in the set of compilation passes.

Example 53 includes the subject matter of example 52, where the subset of other compilation passes includes one or more adaptation passes and one or more optimization passes.

Example 54 includes the subject matter of any one of examples 40-53, where the binary executable is executable to cause a static allocation of the plurality of hardware barrier components to implement the barrier tasks.

Example 55 includes the subject matter of example 54, where the binary executable is executable to cause the static allocation based on a particular graph coloring algorithm.

Example 56 includes the subject matter of any one of examples 40-55, where the binary executable is executable to cause a dynamic allocation of the plurality of hardware barrier components at the target computing device to implement the set of barrier tasks.

Example 57 includes the subject matter of any one of examples 40-56, where the data includes a target descriptor file to identify attributes of the plurality of hardware barriers components, and the set of barrier tasks is to be allocated to hardware barrier components in the plurality of hardware barrier components based at least in part on the attributes.

Example 58 includes the subject matter of any one of examples 40-57, where the set of barrier tasks are based on a set of rules.

Example 59 includes the subject matter of any one of examples 40-58, where one or more of the set of barrier tasks are inserted to control the start of a second one of the set of operations that is to use data generated from completion of a first one of the set of operations.

Example 60 includes the subject matter of example 59, where one or more of the set of barrier tasks are inserted based on timing of a direct memory access (DMA) operation in the set of operations.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results.

What is claimed is:

1. At least one machine-readable storage medium with instructions stored thereon, wherein the instructions are executable by a machine to cause the machine to:
receive, at a compiler, a graph describing a neural network;
access data to describe a target computing device to implement the neural network, wherein the target computing device comprises a plurality of hardware barrier components;
generate, at the compiler, an intermediate representation of the graph, wherein the intermediate representation identifies a set of operations to be performed to implement the neural network;
determine dependencies between the set of operations;
determine a set of barrier tasks to be performed to control flow of the set of operations based on the dependencies, wherein the set of barrier tasks are to be performed using the plurality of hardware barrier components;
insert indications of the barrier tasks into the intermediate representation; and
generate a binary executable based at least in part on the indications of the barrier tasks.

2. The storage medium of claim 1, wherein the indications are inserted as new nodes in a graph model of the intermediate representation to represent the set of barrier tasks in the flow of the set of operations.

3. The storage medium of claim 2, wherein the instructions are further executable to cause a machine to generate respective barrier task objects for each of the set of barrier tasks.

4. The storage medium of claim 3, wherein the barrier tasks objects are to identify attributes of the corresponding barrier task for use in allocating one of the hardware barrier components to implement the corresponding barrier task.

5. The storage medium of claim 2, wherein the intermediate representation comprises an operator model, a control model, and a data model, and the graph model comprises at least one of the operator model, the control model, and the data model.

6. The storage medium of claim 4, wherein the indications are inserted into the control model.

7. The storage medium of claim 4, wherein the dependencies are determined from at least one of the operator model or the control model.

8. The storage medium of claim 1, wherein the instructions are further executable to cause a machine to perform a set of compilation passes using the compiler, and at least a particular one of the set of compilation passes is to allocate a respective one of the plurality of hardware barrier components to implement each one of the barrier tasks.

9. The storage medium of claim 8, wherein at least another one of the set of compilation passes is to determine the set of barrier tasks based on the intermediate representation.

10. The storage medium of claim 8, wherein the particular compilation pass is to be performed after a subset of other compilation passes in the set of compilation passes.

11. The storage medium of claim 10, wherein the subset of other compilation passes comprises one or more adaptation passes and one or more optimization passes.

12. The storage medium of claim 1, wherein the binary executable is executable to cause a static allocation of the plurality of hardware barrier components to implement the barrier tasks.

13. The storage medium of claim 12, wherein the binary executable is executable to cause the static allocation based on a particular graph coloring algorithm.

14. The storage medium of claim 1, wherein the binary executable is executable to cause a dynamic allocation of the plurality of hardware barrier components at the target computing device to implement the set of barrier tasks.

15. The storage medium of claim 1, wherein the data comprises a target descriptor file to identify attributes of the plurality of hardware barriers components, and the set of barrier tasks is to be allocated to hardware barrier components in the plurality of hardware barrier components based at least in part on the attributes.

16. A method comprising:
receiving, at a compiler, a graph describing a neural network;
accessing data to describe a target computing device to implement the neural network, wherein the target computing device comprises a plurality of hardware barrier components;
generating, at the compiler, an intermediate representation of the graph, wherein the intermediate representation identifies a set of operations to be performed to implement the neural network;
determining dependencies between the set of operations;
inserting, in the intermediate representation, indications of hardware barriers in the plurality of hardware barrier components to be used when performing the set of operations based on the dependencies; and
generating a binary executable based at least in part on the indications of the hardware barriers.

17. The method of claim 16, wherein the indications represent a set of barrier tasks to be performed to allocate use of the plurality of hardware barrier components.

18. The method of claim 17, further comprising generating respective barrier task objects for each of the set of barrier tasks, wherein the barrier tasks objects are to identify attributes of the corresponding barrier task for use in allocating one of the hardware barrier components to implement the corresponding barrier task.

19. A system comprising:
a data processor;
a memory; and
a compiler, executable by the data processor to:
receive a graph describing a neural network;
access data to describe a target computing device to implement the neural network, wherein the target computing device comprises a plurality of hardware barrier components;
generate an intermediate representation of the graph, wherein the intermediate representation identifies a set of operations to be performed to implement the neural network;
determine dependencies between the set of operations from the intermediate representation;
determine, based on the dependencies, a set of barrier tasks to be performed to control start of at least some of the set of operations;
insert indications of the set of barrier tasks in the intermediate representation;
determine allocation information for allocating hardware barrier components in the plurality of hardware barrier components to implement each of the set of barrier tasks; and
generate a binary executable based at least in part on the allocation information.

20. The system of claim 19, wherein the compiler is further executable to:
generate a respective barrier task object for each of the set of barrier tasks; and
populate each of the barrier task objects with information to facilitate allocation of hardware barrier components in the plurality of hardware barrier components to implement the set of barrier tasks.

21. The system of claim 19, wherein the allocation information defines a static allocation of the hardware barrier components to the barrier tasks based on a particular Barrier-Interference-Graph (BIG) coloring algorithm.

22. The system of claim 19, wherein the allocation comprises a dynamic allocation, and the target computing device is to dynamically allocate the hardware barrier components to implement the set of barrier tasks at runtime based on the allocation information.
